(19) United States
(12) Patent Application Publication
(10) Pub. No.: US 2004/0261701 A1
(43) Pub. Date: Dec. 30, 2004

(54) Coating apparatus and coating method

(76) Inventors: Shinji Kobayashi, Kikuchi-Gun (JP); Takahiro Kitano, Kikuchi-Gun (JP); Masateru Morikawa, Kikuchi-Gun (JP); Norihisa Koga, Kikuchi-Gun (JP); Tomohide Minami, Kikuchi-Gun (JP); Shinichi Sugimoto, Kikuchi-Gun (JP); Jun Ookura, Kikuchi-Gun (JP); Hiroaki Kurishima, Kikuchi-Gun (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/482,785

(22) PCT Filed: Jul. 1, 2002
(86) PCT No.: PCT/JP02/06646

(30) Foreign Application Priority Data
Jul. 3, 2001 (JP) 2001-202335
Sep. 5, 2001 (JP) 2001-269321

(51) Int. Cl. B05C 11/00

(52) U.S. Cl. 118/696; 427/427.2

(57) ABSTRACT

A coating solution is supplied to a substrate as an experimental substrate that is the same type as a product substrate while the experimental substrate is being scanned by a nozzle so as to form a line of the coating solution. The line of the coating solution is photographed by for example a CCD camera so as to obtain a contact angle of the coating solution. Using a geometric model according to the contact angle, relation data of a discharge flow amount of the coating solution nozzle at a scanning speed for a real coating process for the product substrate and an allowable range of a pitch is obtained. Relation data of the discharge flow amount of the coating solution nozzle and the pitch is pre-created for each of a plurality of targets of the film thickness. According to the relation data, the pitch is decided.

### BACKGROUND OF THE INVENTION

1. Field of the Invention

The present invention relates to a coating apparatus and a coating method for coating for example a resist solution or a coating solution of a material of an insulation film or a protection film on a substrate to be processed such as a semiconductor wafer or an LCD substrate (a glass substrate for a liquid crystal display) so as to form a coating film thereon.

2. Description of the Related Art

In a fabrication process for a semiconductor device and an LCD, to form a resist pattern on a substrate, a coating step, an exposing step, and a developing step for a resist solution are performed. In the coating step for the resist solution, the resist solution is coated by the so-called spin coating method. In the method, a spin chuck that is rotatable is disposed in a cup that surrounds all the periphery of a substrate. The spin chuck horizontally sucks and holds a wafer W. While a nozzle disposed above a center portion of the wafer W supplies a resist solution to the wafer W, the wafer W is rotated. Thus, centrifugal force on the wafer W causes the resist solution to be spread on the entire surface of the wafer W.

However, in the foregoing method, since the wafer W is rotated at high speed, the peripheral speed of an outer peripheral portion is larger than that of an inner peripheral portion. In particular, when the size of the wafer W is large, air turbulence adversely takes place in the outer peripheral portion. Since the air turbulence causes the film thickness to deviate, the film thickness of the entire wafer W becomes ununiform, thereby preventing a fine pattern from being formed. In addition, in this method, the resist solution is spread in such a manner that it is blown off from the center portion of the wafer W in the peripheral direction. Thus, since the resist solution splashes from the peripheral portion to the cup side, the amount of resist solution that is wasted increases.

In such a situation, a method other than the spin coating method has been studied. In a studied method, as shown in FIG. 29, while a resist solution RE is being supplied from a small-diameter discharge opening of a nozzle N disposed above the wafer W, the nozzle N is reciprocally moved in an X direction and the wafer W is intermittently moved in an Y direction. In other words, the resist solution is supplied in the so-called single stroke manner to the wafer W. In this case, to prevent the resist solution from adhering to the periphery and the rear surface of the wafer W, it is preferred to cover other than a circuit forming area of the wafer W with a mask. In such a method, since the wafer W is not rotated, the foregoing problem is solved and the resist solution can be coated without loss.

However, in such a scan coating method, to obtain a desired film thickness, conditions such as a discharge amount and a discharge pressure of the resist solution RE, a scanning speed of the coating solution nozzle N (a moving speed of the coating solution nozzle N in the X direction shown in FIG. 29), and a moving pitch dp of coating solution nozzle N (a moving distance of the nozzle in the Y direction shown in FIG. 29) should be set. In this case, the resist solution RE is of which a resist as a solid component is dissolved with a solvent. When a concentration of the solid component and a film thickness target of the resist film are obtained, since an area of the wafer W has been set, a volume of the resist as the solid component of the wafer W is obtained. As a result, a total amount of the coating solution coated on the wafer W is obtained. Consequently, when the scanning speed of the nozzle N is obtained, the relation of the moving pitch dp of the coating solution nozzle N and the discharge flow amount is obtained. In other words, to increase the discharge flow amount, it is also necessary to increase the moving pitch dp. In contrast, to decrease the discharge flow amount, it is also necessary to decrease the moving pitch dp as is intuitionally understood.

However, when the moving pitch dp is too small, as will be shown in FIG. 6, a line of the coating solution protrudes from a predetermined position set by the moving pitch dp. In other words, so-called forward protrusion phenomenon takes place. This phenomenon tends to take place when the film thickness of the coating film is large. In contrast, when the moving pitch dp is too large, as will been shown in FIG. 3, a phenomenon of which lines do not overlap takes place. This phenomenon tends to take place when the film thickness is small. In any case, the film thickness becomes ununiform. Thus, although it is necessary to coat the coating solution at a proper moving pitch dp for a particular film thickness target, even if the moving pitch dp is proper for the particular film thickness target, if the film thickness is changed, the moving pitch dp may be not always proper. In addition, the moving pitch dp is affected by the material of a base film to be coated on a substrate. Thus, the conditions should be set on trial and error basis. As a result, the coating process becomes complicated and requires a long time. Consequently, the coating apparatus cannot be quickly started.

On the other hand, when the nozzle is moved in the radius direction of the wafer W while it is being rotated so as to spirally coat a coating solution on the wafer, the volume of the coating solution coated on the front surface of the wafer W is dependent on the film thickness target. Thus, when the discharge flow amount of the coating solution discharged from the nozzle is constant, the discharge time after the discharge is started until it is stopped, namely the scan time of the coating nozzle in the radius direction, is obtained. It is necessary to decide the scanning speed of the coating nozzle (the moving speed in the radius direction) and the number of rotations of the wafer W so as to obtain an optimum peripheral speed of the front surface of the wafer W against the coating nozzle. However, when the wafer W is rotated, the peripheral speed of the wafer W is the highest at the outermost periphery thereof. Thus, assuming that the number of rotations of the wafer W and the scanning speed of the coating nozzle are constant, the line width of the coating solution is the smallest at the outermost periphery whose peripheral speed is the highest. Thus, a gap may take place between adjacent lines. When the rotating speed of the wafer W becomes high, the coating solution may be laterally spread, not coated in a desired line shape. As a result, the film thickness of the surface of the wafer W becomes ununiform.

Thus, when the coating solution is spirally coated, it is necessary to increase the scanning speed of the coating nozzle as it is moved on the outer periphery side so that the intervals of adjacent lines become uniform and the film thickness of the surface becomes uniform.

However, since there are many conditions to be set in the coating process, besides the foregoing combination of the scanning speed of the coating nozzle and the number of rotations of the wafer, the coating state varies depending on the state of the surface on which the coating solution is coated, namely, a surface tension depending on the type of a film formed on the front surface of the wafer W, a type (viscosity) of a coating solution, and a supplying speed of the coating solution, and so forth. Thus, it was difficult to adjust them.

### SUMMARY OF THE INVENTION

The present invention is made from the foregoing point of view. An object of the present invention is to provide a technology that allows an operator to easily set parameters (conditions) of a coating process for coating a coating solution in a single stroke manner on a substrate so as to reduce his or her labor. Another object of the present invention is to provide a technology that allows a coating solution to be spirally coated on a substrate so as to form a coating film on the substrate with a uniform film thickness.

A main aspect of the present invention is a coating apparatus, comprising: a supplying mechanism for supplying a coating solution to a substrate while alternately moving a nozzle in a first direction and in a second direction almost perpendicular to the first direction, and relatively to the substrate; a first storing portion for storing a first relation data of a discharge flow amount of the coating solution and a coating width of a line of the coating solution supplied to the substrate at a predetermined moving speed of the nozzle; a second storing portion for storing a second relation data of the discharge flow amount and a pitch that is a moving distance of the nozzle in the second direction almost perpendicular to the first direction for each of a plurality of targets of the film thickness on the substrate at the predetermined moving speed of the nozzle; and means for calculating an allowable range of the pitch according to a selected target of the plurality of targets, the stored first relation data and the second relation data.

According to the present invention, the relation data of a discharge flow amount of a coating solution and the coating width of a line of the coating solution supplied to a substrate at a predetermined moving speed of the nozzle is stored in the first storing portion. The relation data of the discharge flow amount and the pitch, which is the moving distance in a direction almost perpendicular to the direction of the nozzle for each of a plurality of targets of the film thickness at the predetermined moving speed of the nozzle is stored in the second storing portion. According to those two types of the relation data stored, the allowable range of the pitch of the nozzle is obtained. According to the present invention, by supplying a coating solution to a substrate while moving the nozzle in the calculated allowable range of the pitch, a coating film can be uniformly formed with a desired thickness. Thus, conditions of the coating process can easily be set and the coating process can be quickly performed.

In the foregoing description, with respect to the moving speed of the nozzle, “predetermined” does not represent a particular value, but those relation data can be stored for each of different moving speeds.

Another aspect of the present invention further comprises: photographing means for photographing the line of the coating solution supplied to the substrate; and means for calculating the coating width of the line of the coating solution of the first relation data according to a photographed result of the photographing means. The coating width can be obtained according to the contact angle of the coating solution obtained from the photographed result of for example the photographing means. Since the coating solution supplied to the substrate can be considered as a part of a nearly cylindrical shape, the contact angle can be geometrically calculated. According to the present invention, the coating solution is photographed by the photographing means so as to obtain the contact angle. The coating width is calculated with only the contact angle. Thus, the present invention contributes to easily and quickly setting the conditions of the coating process.

In addition, the present invention includes a concept of which a coating solution coated on a product substrate is photographed and the coating width of a line of the coating solution is calculated on real time basis according to the photographed result. In this case, when the coating width of a first line of the coating solution is calculated, the allowable range of the pitch can be calculated.

As another aspect of the present invention, the calculating means is configured to treat one of a first value obtained from a graph representing the first relation data and a second value of which a margin is allowed to the first value as an upper limit value of the pitch. When the moving speed of the nozzle, the viscosity of the coating solution, and the film thickness target of the coating solution have been set, the amount of the coating solution per substrate can be obtained and the pitch can be obtained. The upper limit value of the pitch can easily be defined for example in a condition of which the pitch is smaller than the coating width. The reason why a condition of which the pitch should be smaller than the coating width is set is in that under such a condition adjacent lines of the coating solution overlap. Since a situation of which adjacent lines do not overlap is defective, such a situation is not assumed.

As another aspect of the present invention, the calculating means for calculating the allowable range of the pitch is configured to obtain a limit pitch of which the coating solution protrudes from a predetermined position dependent of the pitch as a function of the coating width according to a geometric model and to obtain a lower limit value of the pitch according to the limit pitch. This is because if a line of the coating solution protrudes from the predetermined position, the film thickness becomes ununiform. In addition, it becomes difficult to calculate the allowable range of the pitch according to the geometric shape of the coating solution.

As another aspect of the present invention, the coating apparatus further comprises: means for displaying the allowable range of the pitch. With such configuration, for example, an operator can easily detect the allowable range, thus the conditions such as the pitch can easily be set.

As another aspect of the present invention, the second relation data is stored in the second storing portion according to each of a plurality of viscosities of the coating solution. The viscosity of the coating solution (the content of the solid component of resist) is a parameter for the pitch. Thus, when the second relation data is stored for the viscosity of each coating solution, even if a coating solution with a different viscosity is coated, since only the allowable range of the pitch needs to be set, the conditions can easily be set.

Another aspect of the present invention is a coating method for supplying a coating solution to a substrate while alternately moving a nozzle in a first direction and a second direction almost perpendicular to the first direction, and relatively to the substrate, the coating method comprising the steps of: calculating an allowable range of a pitch according to a first relation data of a discharge flow amount of the coating solution and a coating width of a line of the coating solution supplied to the substrate at a predetermined moving speed of the nozzle, a second relation data of the discharge flow amount and the pitch that is a moving distance of the nozzle in the second direction almost perpendicular to the first direction for each of a plurality of targets of the film thickness on the substrate at the predetermined moving speed, and a selected target of the plurality of targets; and supplying the coating solution to the substrate in the calculated allowable range of the pitch.

According to the present invention, the allowable range of the pitch of the nozzle is calculated according to the first relation data and the second relation data, which are two types of stored relation data. According to the present invention, by supplying a coating solution to a substrate while moving the nozzle in the calculated allowable range of the pitch, a coating film can be uniformly formed with a desired thickness. Thus, conditions of the coating process can easily be set and the coating process can be quickly performed.

In the foregoing description, with respect to the moving speed of the nozzle, “predetermined” does not represent a particular value, but those relation data can be stored for each of different moving speeds. In addition, the present invention includes a concept of which a line having a coating width of a coating solution coated on a product substrate is calculated on real time basis. In this case, when the coating width of a first line of the coating solution is calculated, the allowable range of the pitch can be calculated.

Another aspect of the present invention is the coating method further comprising the steps of: forming a line of the coating solution while moving the nozzle to an experimental substrate having the same surface state as the substrate as a product substrate and supplying the coating solution to the experimental substrate; storing the first relation data and the second relation data when the coating solution is supplied to the experimental substrate; and supplying the coating solution to a product substrate in the allowable range of the pitch, wherein the calculating step is preceded by the forming step, the storing step, and the supplying step. According to the present invention, an experimental substrate having the same surface state as a product substrate is used. A coating solution is supplied to the experimental substrate so as to pre-obtain the first relation data and the second relation data. Thus, the conditions for the coating process can be more easily set than the foregoing method. As a result, the coating process can be quickly started.

Another aspect of the present invention is a coating apparatus for causing a nozzle to face a substrate horizontally held by a substrate holding portion, causing the nozzle to discharge the coating solution while moving the nozzle in an X direction, and relatively moving the nozzle in a Y direction against the substrate holding portion, and repeating the operations so as to coat the coating solution on the substrate and form a coating film thereon, the apparatus comprising: executing means for causing the nozzle to scan an experimental substrate having the same surface state as the substrate as a product substrate, while causing the nozzle to supply the coating solution to the experimental substrate so as to form a line of the coating solution on the experimental substrate; photographing means for photographing the line of the coating solution; a first calculating means for obtaining relation data of a flow amount discharged from the nozzle at a scanning speed for a real coating process and an allowable range of a pitch that is an intermittent moving distance of the product substrate against the nozzle in a Y direction according to a photographed result of the photographing means; storing means for storing a relation data of the flow amount of the nozzle dependent of a target of a film thickness on the substrate at the scanning speed for the real coating process and the pitch; and a second calculating means for calculating the allowable range of the pitch according to the relation data of the flow amount and the pitch according to the target of the film thickness and the relation data obtained by the first calculating means.

As another aspect of the present invention, the calculating means may be configured to obtain the relation data according to a contact angle of the contact solution obtained from the photographed result. The first calculating means may be configured to obtain a graph representing a relation of the flow amount of the nozzle and a coating width of the line of the coating solution according to the contact angle and treats one of a first value obtained from the graph and a second value of which a margin is allowed to the first value as an upper limit value of the pitch. The calculating means may be configured to obtain a limit pitch of which the coating solution forward protrudes from a predetermined position dependent of the pitch for the real coating process as a function of the coating width according to a geometric model and to obtain a lower limit value of the pitch according to the limit pitch. The pitch allowable range deciding means has means for displaying the allowable range of the pitch. As another aspect of the present invention, while the experimental substrate is being held by the substrate holding portion, an experimental coating process is performed with the nozzle used for the product substrate. According to the coating apparatus of the present invention, when the scanning speed has been set, since the pitch dp according to the film thickness target can be obtained, the condition can easily be set.

According to the present invention, the photographing means may be disposed so as to move in the Y direction relative to the substrate holding portion and configured to photograph the coating solution discharged from the nozzle for the real coating process. The coating apparatus may further comprise determining means for determining a discharge state of the nozzle according to a photographed result of the photographing means.

The present invention can be also accomplished as a coating method. This method comprises the steps of: causing a nozzle used for a product substrate having the same surface state as an experimental substrate to supply a coating solution to the experimental substrate while scanning it so as to form a line of the coating solution; photographing the line of the coating solution; obtaining relation data of a discharge flow amount of the nozzle at a scanning speed for the product substrate and an allowable range of the pitch as a relative intermittent moving distance of the substrate in a Y direction against the nozzle according to the photographed result at the photographing step; and deciding the pitch according to the relation data obtained at the relation data obtaining step and relation data of the discharge flow amount of the nozzle for the film thickness target at the scanning speed for the product substrate and the pitch.

Another aspect of the present invention is a coating apparatus, comprising: means for supplying the coating solution on a front surface of a substrate in a spiral shape while relatively moving a nozzle for discharging a coating solution in a radius direction of the substrate being rotated; a storing portion for correlatively storing, for each of a plurality of targets of the film thickness, a line width of the coating solution supplied to the substrate, the moving pattern defining a relation of a position of the nozzle on the substrate and a moving speed of the nozzle and a rotating pattern defining a relation of the position of the nozzle on the substrate and the number of rotations of the substrate; and a controlling portion for controlling a movement of the nozzle and the rotation of the substrate according to the line width of the coating solution, the moving pattern, and the rotating pattern stored in the storing portion so as to supply the coating solution to the substrate.

According to the present invention, the line width of a coating solution, a moving pattern and a coating pattern for each of a plurality of targets of the film thickness is correlatively stored. According to the stored data, the movement of the nozzle and the rotation of the substrate are controlled so as to supply the coating solution to the substrate. Thus, by setting the film thickness target and measuring the line width of the coating solution, an optimum coating condition with respect to the moving condition of the nozzle and the rotating condition of the substrate is obtained regardless of the type of the coating solution and the type of the wafer. Thus, the labor of the initial setting operation can be alleviated.

In addition, the present invention includes a concept of which a line width of a coating solution coated on a product substrate is calculated on real time basis. In this case, after the line width of a line that has been coated is measured, a combination of a moving pattern and a rotating pattern that has been stored is selected according to the measured line width. According to the selected combination, the controlling portion controls the movement of the nozzle and the rotation of the substrate so as to supply the coating solution to the substrate. According to the present invention, the coating solution may be supplied to an experimental substrate so as to measure the line width thereof. The line width measuring means have means for photographing a line of the coating solution and means for processing a photographed image and obtaining the line width.

Another aspect of the present invention is a coating method for relatively moving a nozzle for discharging a coating solution in a radius direction of a substrate being rotated while supplying the coating solution on a front surface of the substrate in a spiral shape, the coating method comprising the steps of: reading a combination information of a moving pattern and a rotating pattern according to a predetermined line width for each of a plurality of targets of the film thickness, from information of which a line width of the coating solution supplied to the substrate, the moving pattern defining a relation of a position of the nozzle on the substrate and a moving speed of the nozzle and a rotating pattern defining a relation of the position of the nozzle on the substrate and the number of rotations of the substrate are correlatively stored; and controlling a movement of the nozzle and a rotation of the substrate according to the read combination information and supplying the coating solution to the substrate.

According to the present invention, the line width of a coating solution, a moving pattern and a coating pattern for each of a plurality of targets of the film thickness is correlatively stored. According to the stored data, the movement of the nozzle and the rotation of the substrate are controlled so as to supply the coating solution to the substrate. Thus, by setting the film thickness target and measuring the line width of the coating solution, an optimum coating condition with respect to the moving condition of the nozzle and the rotating condition of the substrate is obtained regardless of the type of the coating solution and the type of the wafer. Thus, the labor of the initial setting operation can be alleviated.

Another aspect of the present invention is a coating apparatus for coating solution on a front surface of a product substrate horizontally held by a substrate holding portion in a spiral shape while rotating the product substrate around a vertical axis and relatively moving a nozzle in a radius direction of the product substrate and causing the nozzle to discharge the coating solution, the coating apparatus comprising: experimentally coating means for experimentally coating the coating solution on an experimental substrate having the same surface as the product substrate; line width measuring means for measuring a line width of the coating solution coated on the experimental substrate coated by the experimental coating means; a storing portion for correlatively storing the line width of the coating solution coated on the experimental substrate, a moving pattern defining a relation a position of the nozzle and a moving speed of the nozzle in a real coating process for the product substrate, and a rotating pattern that defines the position of the nozzle and the number of rotation of the substrate; and a controlling portion for reading the moving pattern and the rotating pattern from the storing portion according to the line width of the coating solution measured by the line width measuring means and controlling the nozzle and the substrate holding portion according to the read data so as to form the coating film on the product substrate.

The line width measuring means includes a photographing means for photographing a line of the coating solution and a means for processing the photographed image. The experimentally coating means may comprise another substrate holding portion other than the substrate holding portion that holds the product substrate and another nozzle other than the nozzle that supplies the coating solution to the product substrate. Alternatively, the substrate holding portion and the nozzle for the product substrate may be used in common with those for the experimental substrate. According to the present invention, by experimentally coating a coating solution on an experimental substrate, an optimum coating condition can be obtained regardless of the type of the coating solution and the type of the wafer. Thus, the labor of the initial setting operation can be alleviated.

### BRIEF DESCRIPTION OF DRAWINGS

FIG. 1 is a perspective view showing a state of which a resist solution is coated on a wafer according to an embodiment of the present invention.

FIG. 2 is a characteristic diagram showing the relation of a pitch and a discharge flow amount.

FIG. 3 is a descriptive schematic diagram showing a state of which lines of a coating solution do not overlap.

FIG. 4 is a descriptive schematic diagram showing a geometric model for obtaining the relation of a discharge flow amount and a coating width assuming that a line of a coating solution has a cylindrical shape.

FIG. 5 is a characteristic diagram showing a graph of an upper limit and a lower limit of a pitch for each discharge flow amount of a nozzle and relation data of a discharge flow amount and a pitch according to a film thickness target.

FIG. 6 is a descriptive schematic diagram showing a forward protrusion phenomenon of a coating solution.

FIG. 7 is a descriptive schematic diagram showing a geometric model for obtaining a lower limit of a pitch of which the forward protrusion phenomenon of a coating solution does not take place.

FIG. 8 is a characteristic diagram showing a state of which the relation of a discharge flow amount of a nozzle and a coating width of a line of a coating solution varies according to a contact angle.

FIG. 9 is a sectional diagram showing a mechanical portion of a coating apparatus according to an embodiment of the present invention.

FIG. 10 is a plan view showing the mechanical portion of the coating apparatus according to the embodiment of the present invention.

FIG. 11 is a structural schematic diagram showing the mechanical portion and a controlling portion of the coating apparatus.

FIG. 12 is a perspective view showing a state of which a coating process is performed by the coating apparatus.

FIG. 13 is a plan view showing lines of a coating solution drawn on a wafer.

FIG. 14 is a characteristic diagram showing the relation of a coating width and a discharge pressure.

FIG. 15 is a characteristic diagram showing the relation of a discharge flow amount and a discharge pressure.

FIG. 16 is a flow chart showing a modification of the first embodiment.

FIG. 17 is a schematic diagram showing a state of which a coating solution is supplied according to a second embodiment.

FIG. 18 is a characteristic schematic diagram showing an allowable range of a pitch in the case that each nozzle shown in FIG. 17 is used.

FIG. 19 is an overall structural schematic diagram showing an overall structure of a coating film forming apparatus according to a third embodiment.

FIG. 20 is a plan view showing the coating film forming apparatus according to the third embodiment.

FIG. 21 is a descriptive schematic diagram showing a data table stored in a memory.

FIG. 22 is a characteristic schematic diagram showing a moving pattern of a coating nozzle stored in the data table.

FIG. 23 is a characteristic schematic diagram showing a rotating pattern of a wafer stored in the data table.

FIG. 24 is a flow chart describing an operation of the foregoing embodiments.

FIG. 25 is a descriptive schematic diagram showing a coating film forming apparatus according to a modification of the third embodiment.

FIG. 26 is an external view showing a coating and developing system in which a coating apparatus according to the present invention is incorporated.

FIG. 27 is a plan view showing the interior of the coating and developing system in which the coating apparatus according to the present invention is incorporated.

FIG. 28 is a perspective view showing a state of which a coating solution is spirally supplied.

FIG. 29 is a plan view showing a state of which a coating solution is supplied to a wafer from a coating solution nozzle that is scanning the wafer.

### DESCRIPTION OF PREFERRED EMBODIMENTS

[First Embodiment]

Next, a coating film forming method according to an embodiment of the present invention will be described. According to the present embodiment, a resist film forming method will be described. According to the present embodiment, a proper value of a moving pitch dp of a coating solution nozzle is obtained so that a resist solution is coated in a single stroke manner on a wafer W by the coating solution nozzle. In more reality, a resist solution is of which a resist that is a solid component is dissolved with a solvent. When the concentration of the sold component and the scanning speed of the nozzle are known, as will be described later, with a film thickness target set, the relation of a discharge flow amount q and the moving pitch dp of the nozzle is obtained. Thus, from this point of view, the moving pitch dp of the nozzle can be freely set. However, depending on the value of the pitch dp, a phenomenon of which a coating solution protrudes forward or lines thereof do not overlap takes place.

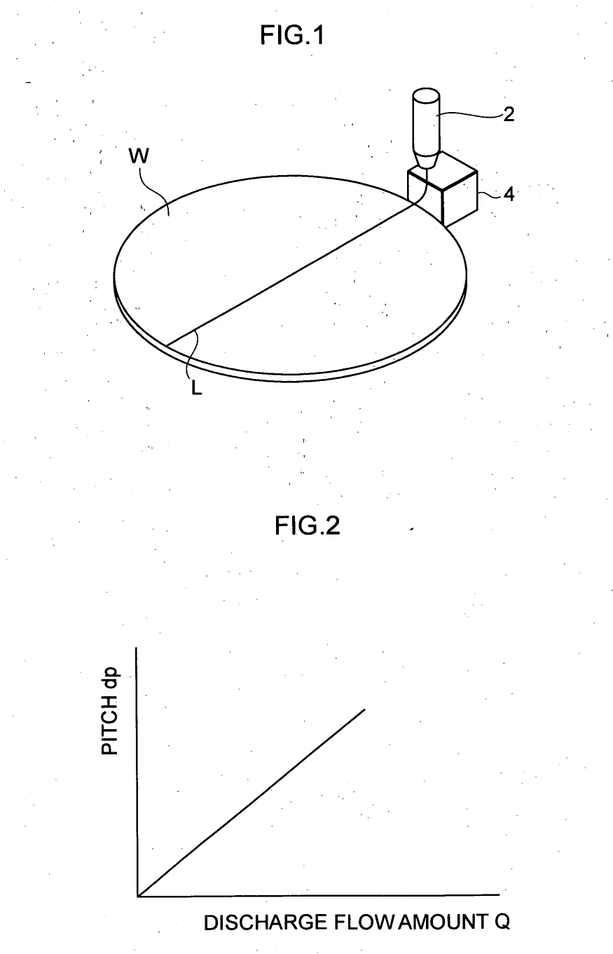

To solve such a problem, according to the present embodiment, as shown in FIG. 1, one line L of a coating solution is drawn by the coating solution nozzle 2 on an experimental substrate (in this example, a wafer W) having the same surface state as a product substrate for which a coating process is performed. The line is photographed by a photographing means 4 that is for example a CCD camera. According to the photographed result, a contact angle is obtained. According to the value of the contact angle, the relation of the discharge flow amount of the nozzle 2 and an allowable range of the moving pitch dp of the nozzle 2 is obtained. According to the obtained relation and the relation of the discharge flow amount and the moving pitch of the nozzle, which depend on the target of the film thickness, a proper range of the moving pitch dp is set.

Next, a coating film forming method according to a first embodiment of the present invention will be described. First, a target of the film thickness of a resist film formed on a substrate is set. For example, it is assumed that the size of the wafer W is 200 mm (so-called 8-inch size), the target of the film thickness is 0.5 μm, the concentration of the solid component of the resist solution is 5.0%, and the scanning speed is 1 m/s.

In this case, the target of the film thickness is given by expression (1).

(Average film thickness 0.5×10⁻⁴)=(amount Q of resist solution coated)×(amount of solid component)/(moving pitch)/(area of wafer W)=Q×5.0/100/dp/(π×10²)=1.59×Q/dp (1)

From the expression (1), expression (2) is obtained.

dp=3.18×10⁴×Q (2)

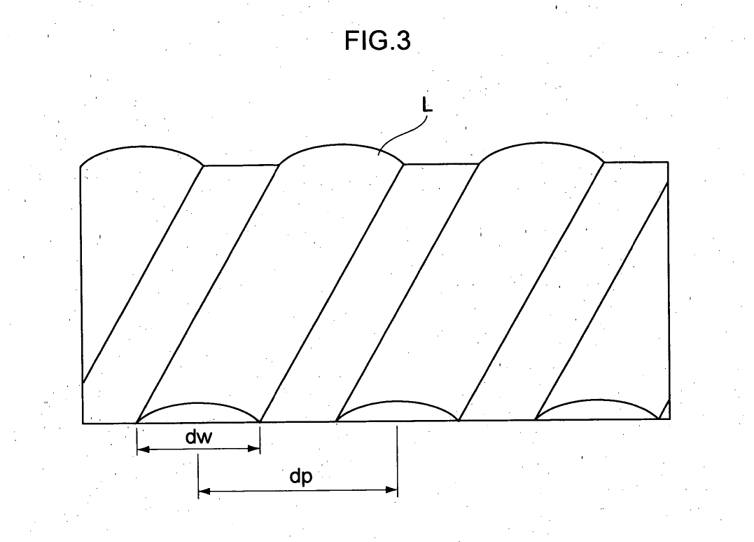

The moving pitch and the amount of the resist solution have a proportional relation. They are drawn on a graph as shown in FIG. 2. According to the present embodiment, since the total amount Q of the resist solution per substrate depends on each film thickness target, there is such a proportional relation. The amount Q of resist solution depends on the moving pitch dp, the discharge flow amount, the scanning speed, and the wafer size. When the moving pitch dp is set as a particular value, the wafer W is equally and straightly divided into n portions. The length of the lines can be geometrically obtained. When the total length of the portions is denoted by G, the amount Q of the resist solution is given by expression (2A).

(Amount Q of resist solution)=(total length G)×(discharge flow amount q)/(scanning speed) (2A)

where the discharge flow amount is the amount of a resist discharged from the nozzle per unit time (that will be defined later as (cm³/minute)).

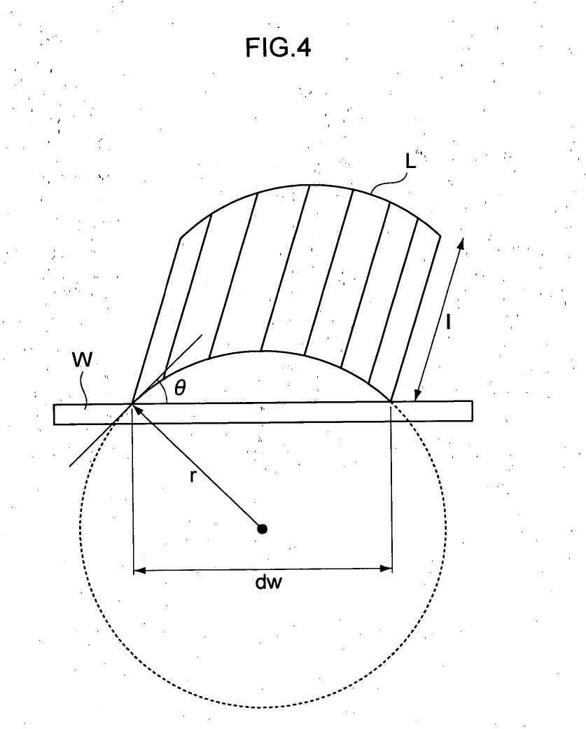

Next, the reason why the value of the moving pitch dp is restricted will be described. FIG. 3 is a descriptive schematic diagram showing the relation of a coating width (line width) dw of a line L of a coating solution coated on the wafer W and a pitch dp. As is clear from FIG. 3, when the pitch dp is too large, a solution (line) does not overall with an adjacent solution (line). A condition of which solutions (lines) overlap is given by expression (3).

Pitch dp<coating width dw (3)

Thus, according to the present embodiment, before a coating process is performed for a wafer W, for example one line of a coating solution is drawn on an experimental wafer W having the surface state as a product wafer at the same scanning speed as the coating process by the nozzle 2. The line is photographed by the photographing means 4, which is for example a CCD camera, so as to obtain a contact angle. With the contact angle, the relation of the discharge flow amount and the coating width dW of the nozzle 2 in the coating system that is actually used (the coating system includes the nozzle 2, the coating solution, the scanning speed, the surface state of the substrate, and so forth) is obtained. The contact angle is an angle of the liquid surface of the resist solution against the wafer where the resist solution contacts the wafer.

FIG. 4 is a schematic diagram showing a state of which a line of a coating solution formed on a wafer W is a part of a cylinder. In FIG. 4, dw represents a coating width (mm) of a line L of a coating solution; l represents a length (mm) of the line L of the coating solution; r represents a radius (mm) of the cylinder; and θ represents a contact angle (degree). A sectional area S (mm²) and a volume V of the line L are given by expressions (4) and (5), respectively.

S=θr²−(1/2)r² sin 2θ (4)

V={θr²−(1/2)r² sin 2θ}·1 (5)

In addition, the relation of the coating width dw and the radius r of the cylinder is given by expression (6). When a scanning speed of the nozzle 2 is denoted by v (mm/sec) and a discharge flow amount thereof is denoted by q (cm³/min), expression (7) is satisfied.

dw=2r sin θ (6)

V=(q1)/60v (7)

When the relation of the coating width dw and the discharge flow amount q is obtained with the expressions (5), (6), and (7), expression (8) is satisfied.

dw=θ{q/K}^{1/2} (8)

where K=15v[θ−(1/2)sin 2θ]

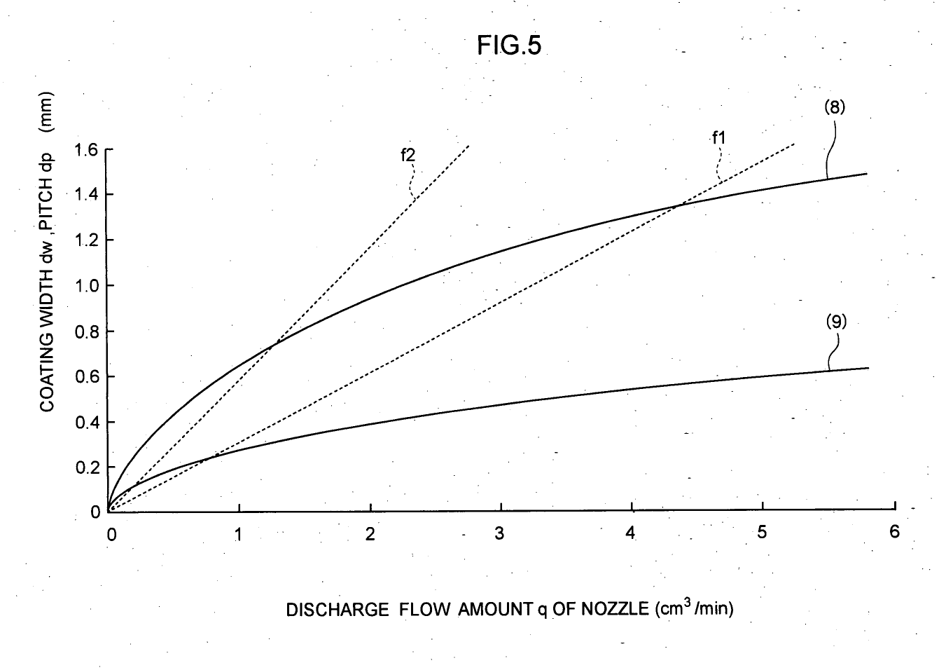

An example of the relation is shown as curve (8) of FIG. 5. In FIG. 5, curve numbers correspond to expression numbers. Thus, from the expression (3), it is required that the pitch dp of the real coating process be in an area lower than the curve (8) of FIG. 5. In other words, the coating width dw defined with the curve (8) represents an upper limit of the pitch dp.

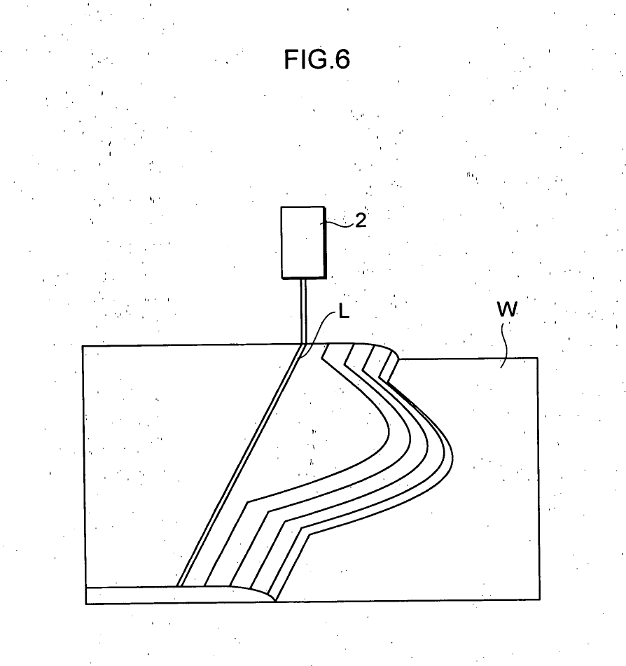

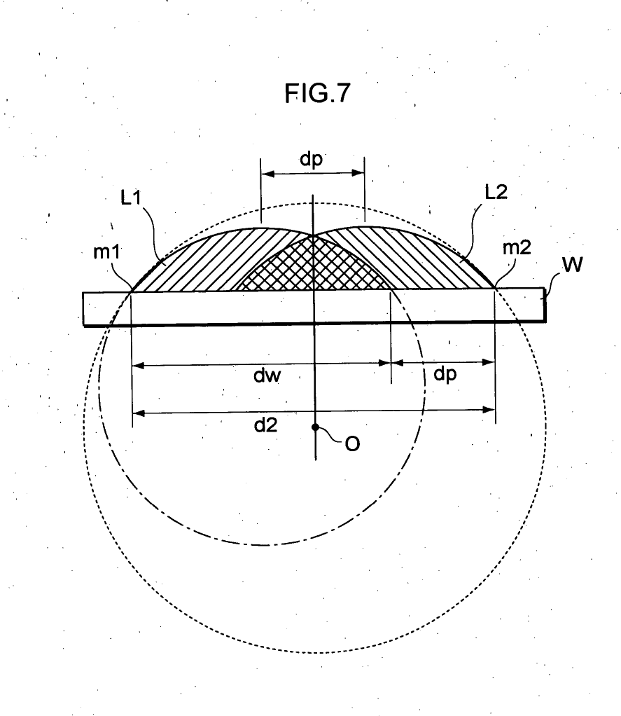

Next, a lower limit of the pitch dp will be described. FIG. 6 is a descriptive schematic diagram showing an exaggerated state of which when the coating solution nozzle 2 successively scans the wafer W, a forward protrusion phenomenon of which the coating solution forward protrudes from a position defined by the pitch dp takes place. When the pitch dp is too small, the forward protrusion phenomenon takes place. Next, with reference to FIG. 7, the limit (lower limit) of the pitch dp will be geometrically considered. In FIG. 7, an upward hatched portion denoted by L1 is a line of a coating solution that has been coated first. A downward hatched portion denoted by L2 is a line of the coating solution coated adjacent to the line L1. When a coating width of the first line is denoted by d1 and a coating width of a line of the coating solution made of the first line and a second line is denoted by d2, the relations of d1=dw and d2=dw+dp are satisfied.

In FIG. 7, a circle represented by a single dashed line contains an arc in an outer shape of the line L1 of the coating solution. m1 and m2 represent a rear edge of the line L1 and a front edge of the line L2, respectively. A circle represented by a dotted line has a center O that is an intersection of two straight lines perpendicular to tangential lines at m1 and m2 of the circle denoted by the single dashed line. In other words, with reference to FIG. 7, a coating solution corresponding to the overlap portion (at which the upward hatched portion and the downward hatched portion overlap) fills a blank portion surrounded by the dotted circle and the outer peripheries of the hatched portions. Thus, if the area of the overlap portion is larger than the blank area, two adjacent lines that overlap protrude from the arc of the line L2. In other words, the forward protrusion phenomenon, of which the coating solution protrudes from a line defined by the pitch dp that has been set, takes place. Thus, when a sectional area of one line of the coating solution is denoted by S1 and a sectional area surrounded by the arc of the dotted line and the front surface of the wafer W is denoted by S2, a condition of which the forward protrusion phenomenon of the coating solution does not take place is given by the relation of S2>2S1. With the condition, the following expression (9) is satisfied.

dp>(2^{1/2}−1)dw (9)

In other words, the lower limit value of the pitch dp is (2^{1/2}−1)dw. This relation is represented as curve (9) of FIG. 5. Thus, when the coating process is performed with a film thickness target set, the relation of the discharge flow amount q of the nozzle 2 and the pitch dp of the nozzle 2 is obtained. When the discharge flow amount q and the pitch dp are set in the range between the curves (8) and (9), adjacent lines of the coating solution overlap with each other and the solution forward protrusion does not take place.

In FIG. 5, curves f1 and f2 denoted by dotted lines (for example, two lines are shown) each represent the relation of a discharge flow amount q and a pitch dp for a particular film thickness. The pitch dp and the discharge flow amount q for the real coating process can be selected in the range between the curves (8) and (9) of the graph of FIG. 5. Assuming that the curve f2 corresponds to a particular film thickness target, the curves f1 corresponds to a film thickness target which is twice that of the curve f2. In a real apparatus, the allowable range of the pitch dp may be in the range between a value slightly lower than the curve (8) and a value slightly higher than the curve (9) so as to have a margin to some extent.

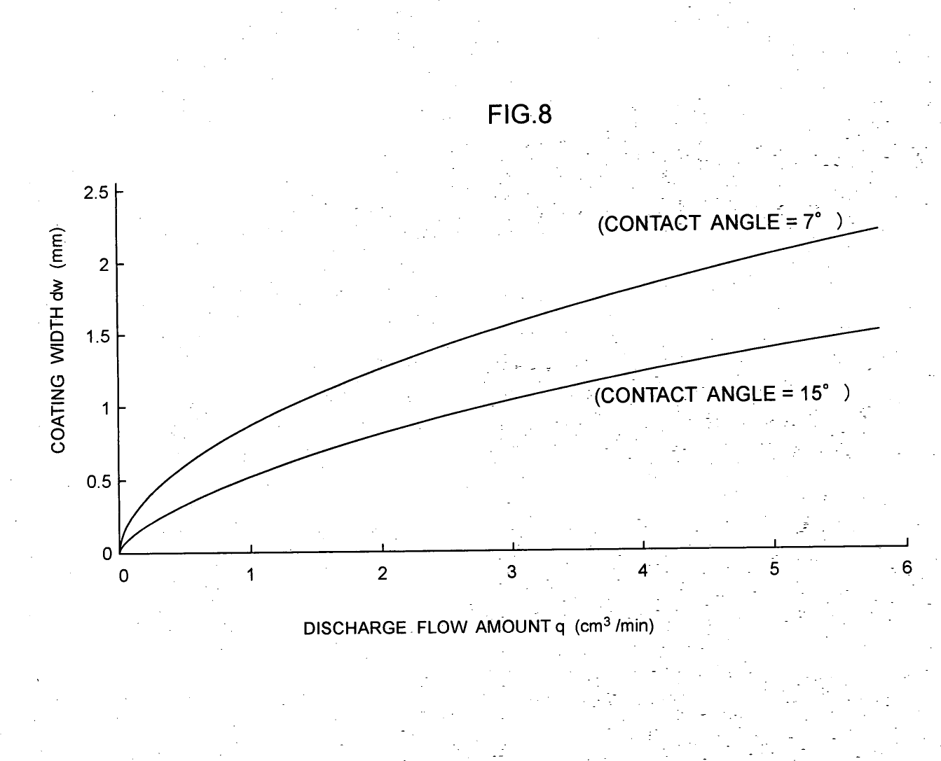

The area depends on a contact angle that depends on the type of a coating solution and the surface state of a wafer W. FIG. 8 shows curves in the case that the contact angle is 7 degrees and 15 degrees in the curve (8) shown in FIG. 5. Since the surface tension is proportional to the contact angle, it is clear that the coating width dw is large. With a contact angle of 15 degrees, the values of the discharge flow amount q and the coating width dw were varied and overlap states of lines of the coating solution were evaluated. Evaluated results represent that when the values of the discharge flow amount q and the coating width dw are below the curve, adjacent lines overlap with each other. In an area of which the discharge flow amount q is larger than 4 cm³/minute, even if their values are above the curve (8) to some extent, adjacent lines overlap with each other. According to the present embodiment, it is important to know the contact angle of the coating solution. However, the contact angle may be directly obtained by the photographed result of a line of the coating solution. Alternatively, the contact angle may be obtained by the sectional area and the coating width dw of a line of the coating solution.

According to the coating method of the present embodiment, a line of a coating solution is experimentally pre-coated on a wafer W. The line is photographed so as to obtain a contact angle. With the contact angle, an upper limit and a lower limit of a pitch dp of each discharge flow amount are obtained. Thus, when the relation of the discharge flow amount q and the pitch dp according to a film thickness target satisfies the allowable range, the value of the pitch dp can be decided. Thus, the parameter (condition) setting operation of the coating process can be reduced.

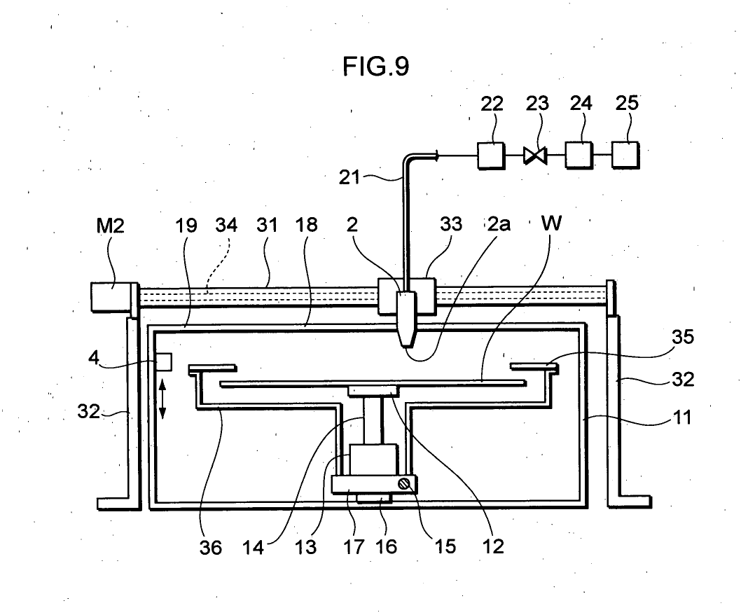

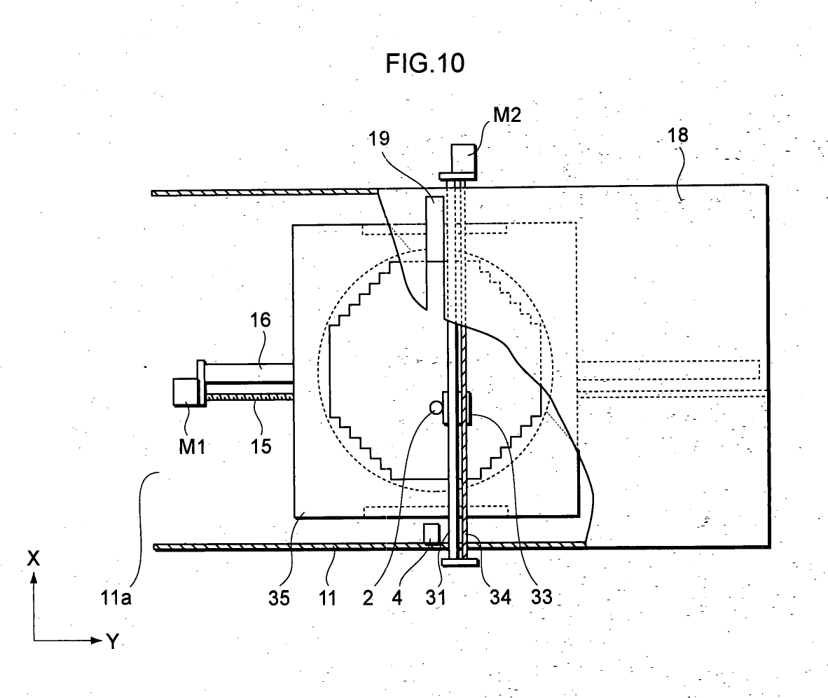

Next, a coating apparatus that performs such a coating method according to an embodiment of the present invention will described. FIG. 9 and FIG. 10 are a sectional view and a plan view showing the coating apparatus, respectively. The coating apparatus has a case body 11 and a wafer holding portion 12. An opening portion 11a (see FIG. 10) that is a wafer loading and unloading opening is formed on a front surface of the case body 11. The wafer holding portion 12 is disposed in the case body 11. The wafer holding portion 12 has a vacuum check function capable of intermittently moving a wafer W in a Y direction of FIG. 10. The wafer holding portion 12 is elevated through an elevating shaft 14 by an elevating mechanism 13. The elevating mechanism 13 is disposed on a moving table 17 that can be moved in the Y direction while being guided by a guide portion 16 with a ball screw portion 15 driven by a motor M1. The motor M1, the ball screw portion 15, and the guide portion 16 compose a Y direction driving mechanism. It is preferred to provide the wafer holding portion 12 with a vibration generating means including an ultrasonic wave oscillator (not shown). After a resist solution is coated on a wafer W, by vibrating the wafer W, a coating film can be more uniformly coated on the wafer W.

A slit 19 is formed in a ceiling plate 18 of the case body 11. The slit 19 extends in an X direction (a part of the slit 19 is shown in FIG. 10). A coating solution nozzle 2 is disposed in the slit 19. An upper portion of the coating solution nozzle 2 protrudes upward from the ceiling plate 18. A discharge opening of the coating solution nozzle 2 is positioned on a lower side of the ceiling plate 18. The discharge opening faces the wafer W. The coating solution nozzle 2 is connected to a solution supply pipe 21. The solution supply pipe 21 is connected to a resist solution supplying source 25 through for example a flow amount adjusting portion 22, a valve 23, and a pump 24. The pump 24 is for example a bellows pump or a diaphragm pump.

Above the ceiling plate 18, a guide portion 31 that extends in the X direction is disposed through a support portion 32. The coating solution nozzle 2 is disposed so that it can be moved along the guide portion 31 through a moving body 33. The moving body 33 is engaged with a ball screw portion 34 that extends in the X direction. The ball screw portion 34 is rotated by a motor M2. As a result, the coating solution nozzle 2 is moved in the Y direction through the moving body 33. The motor M2, the guide portion 31, and the ball screw portion 34 compose an X direction driving mechanism. The moving area of the wafer W is surrounded by the case body 11 so that the wafer W is placed in a narrowly closed space. Thus, while the resist solution is being coated on the wafer W, the case body 11 is filled with a gas of the solvent. Thus, the solvent can be prevented from evaporating from the coated resist solution.

When the coating solution nozzle 2 is moved in the X direction while the coating solution nozzle 2 is discharging the resist solution, the resist solution adheres to the periphery of the wafer W. In addition, the resist solution adheres to the rear surface of the wafer W. To prevent those, a mask 35 that covers the entire periphery of the wafer W and that has a blank portion according to a circuit forming area as a coating film forming area is disposed above the wafer W. The mask 35 is disposed on the moving table 17 that moves the wafer W in the Y direction. The mask 35 is placed on a mask supporting portion 36 that is disposed outside the wafer W and at a slightly higher position than the front surface of the wafer W.

A photographing means 4 that is composed of for example a CCD camera is disposed on an extended line of a reciprocal path of the nozzle 2 on an inner surface of the case body 11. The photographing means 4 is height-adjustably disposed so that a coating solution coated on the wafer W can be photographed in an experimental coating process and a coating solution that is coated on the mask 35 can be photographed in a real coating process.

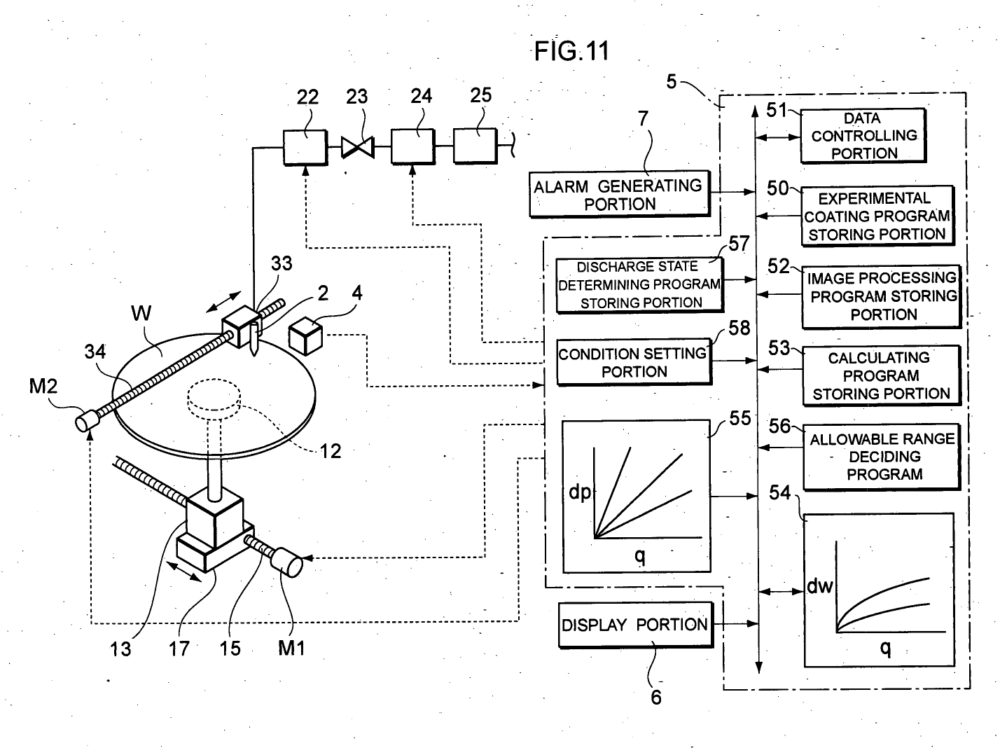

Next, with reference to FIG. 11, a controlling system of the coating apparatus will be described. In FIG. 11, reference numeral 5 represents a controlling portion. Next, each portion contained in the controlling portion 5 and related portions will be described. Reference numeral 51 represents a data processing portion composed of for example a CPU. Reference numeral 50 represents an experimental coating program storing portion that stores a program for causing the nozzle 2 to experimentally coat a coating solution on an experimental wafer W. The program, the data processing portion 51, which executes the program, the nozzle 2, and the substrate holding portion 12 compose an executing means that experimentally coats the coating solution on the wafer W. Reference numeral 52 represents an image process program storing portion that stores an image process program that causes the controlling portion 5 to process image data photographed and captured by the photographing means 4.

Reference numeral 53 represents a calculation program storing portion that stores a calculation program that causes the controlling portion 5 to obtain a contact angle of a coating solution on a wafer W according to a photographed result obtained in an experimentally coating process performed before a real coating process (for a product wafer W), perform calculations for the expressions (8) and (9) according to the contact angle, obtain both the curves shown in FIG. 5, and obtain relation data of the allowable range of the pitch dp for each discharge flow amount of the nozzle 2 (the area between the curves (8) and (9)). The calculation program and the data processing portion 51 compose a calculating means.

Reference numeral 54 represents a first storing portion that stores the curves (8) and (9) obtained by the calculation program. Reference numeral 55 represents a second storing portion that stores the relation data of the discharge flow amount and the pitch dp of the nozzle 2 that depend on each of a plurality of targets of the film thickness (for example, the dotted lines shown in FIG. 5). Reference numeral 56 represents an allowable range deciding program storing portion. The allowable range deciding program storing portion 56 stores a program that causes the controlling portion 5 to obtain the allowable range of the pitch dp for each discharge flow amount according to the relation data stored in the first storing portion 54 and the relation data stored in the second storing portion 55 and the display portion 6 such as a CRT screen to display the obtained result. In the example, the program and the data processing portion 51 compose a means for deciding the allowable range of the pitch dp. The allowable range of the pitch dp may be displayed along with the curves (8) and (9), which represent the upper limit thereof and the lower limit as shown in FIG. 5, and the relation data according to the film thickness target. Alternatively, only the relation data according to the film thickness target may be displayed. The portion of the allowable range may be displayed in a different color from other portions.

Reference numeral 57 represents a discharge state determining program storing portion that stores a program that causes the controlling portion 5 to determine the discharge state of a coating solution discharged from the nozzle 2 according to the photographed result of the photographing means 4 in the real coating process. The program is designed to cause the controlling portion 5 to detect the variation of the sectional area of a line of a coating solution before the nozzle 2 moves to a position according to the next line on the mask 35, determine that the discharge state of the nozzle 2 is unstable when the amount of the variation is large, and an alarm generating portion 7 to issue an alarm. To cause the controlling portion 5 to perform the determination, it is preferred to photograph a coating solution coated on the wafer W and detect the variation of the sectional area of a line of the coating solution. However, according to the present embodiment, since the mask 35 is used, such a method is used. The program and the data processing portion 51 compose a determining means.

A condition setting portion 58 serves to set the intermittent drive amount of the motor M1 according to the discharge flow amount of the nozzle 2, and the number of rotations of the motor M2 according to the scanning speed of the nozzle 2. The condition setting portion 58 is composed of for example a touch panel.

The discharge flow amount of the nozzle 2 may be adjusted by the flow amount adjusting portion 22. However, when the bore of the nozzle 2 has been set, since the relation of the discharge flow amount and the discharge pressure is unconditionally obtained according to the amount of the solid component of the coating solution, by detecting the discharge pressure and adjusting the discharging operation of the pump 24, the discharge flow amount may be adjusted.

Next, an operation of the foregoing coating apparatus will be described. When a coating process is performed for a wafer W of particular type, an experimental wafer W having the same surface state as a product wafer W is horizontally held by the wafer holding portion 12. The position of the wafer holding portion 12 is set by the motor M1 so that a center portion of the wafer W is placed immediately below a scan area of the nozzle 2. In this process, the foregoing mask 35 is not used. The photographing means 4 is set at a position of which a coating solution on the front surface of the wafer W is photographed. While the coating solution is being discharged from the nozzle 2 to the wafer W, the nozzle 2 is moved in the X direction so as to draw one line of the coating solution on the wafer W. This operation is executed by the foregoing experimental coating program. This line is laterally photographed by the photographing means 4. An image process is performed for the photographed image by the image processing program so as to obtain a contact angle of the coating solution. The foregoing curves (8) and (9) are obtained by the calculation program according to the contact angle and stored in the first storing portion 54.

On the other hand, the relation data of the discharge flow amount and the pitch dp of lines of the coating solution for each of a plurality of targets of the film thickness is stored in the second storing portion 55 in the state that the concentration (viscosity) of the solid component of the coating solution and the scanning speed of the nozzle 2 have been set. When the scanning speed is constant, the relation data of the discharge flow amount and the pitch dp with a parameter of the film thickness target is stored for the concentration of each solid component. The concentration of the solid component and the film thickness target of the coating solution used in the real coating process are set and the corresponding relation data is selected from the second storing portion 55. The allowable range deciding program causes the display portion 6 to display the relation data selected from the second storing portion 55 and the relation data stored in the first storing portion 54 together. The operator knows the allowable range of the pitch dp from the display data displayed on the display portion 6 and sets the pitch dp and the corresponding discharge flow amount. The controlling portion 5 may set a center value of the allowable range as a set value of the pitch dp.

After the pitch dp and the discharge flow amount have been set, a real coating process is performed for a product wafer W. The wafer W is placed on the wafer holding portion 12 by an arm (not shown). Thereafter, the mask 35 is placed on the mask supporting portion 36 by the arm. Assuming that an edge portion of the wafer W on the inner side (the right side of FIG. 10) of the case body 11 viewed from the opening portion 11a thereof is a front edge portion, the wafer holding portion 12 is positioned so that the front edge portion of the wafer W is placed immediately below the scan area in the X direction of the coating solution nozzle 2. The wafer holding portion 12 is intermittently moved in the inner direction of the case body 11 by the ball screw portion 15 while the wafer holding portion 12 is being guided by the guide portion 16.

On the other hand, the coating solution nozzle 2 is reciprocally moved in the X direction according to the timing of the intermittent movement of the wafer W. In other words, when the wafer W is stopped, the coating solution nozzle 2 is moved from a first end side to a second end side while the coating solution nozzle 2 is discharging the coating solution on the wafer W. Thereafter, the wafer W is moved by a predetermined amount (predetermined pitch) in the Y direction by the wafer holding portion 12. The coating solution (resist solution) is sucked from the resist solution supplying source 25 by the pump 24. Thereafter, the bellows is pushed so that the resist solution is discharged from the coating solution nozzle 2 by a predetermined amount.

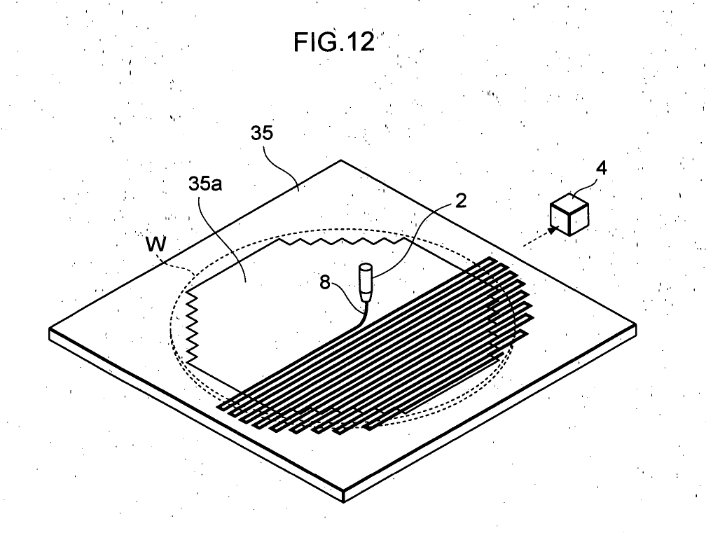

The coating solution nozzle 2 returns on the second end side and then moves on the first end side while the coating solution nozzle 2 is discharging the coating solution on the wafer W. FIG. 12 is a descriptive schematic diagram showing such a state. The resist solution 8 is discharged from the coating solution nozzle 2 and coated on the wafer W in a single stroke manner. The periphery of the circuit forming area of the wafer W is contoured with stepped lines. An opening portion 35a of the mask 35 accords with the stepped lines. However, the outer periphery of the opening portion 35a is slightly larger than that of the stepped lines. In such a manner, the resist solution is coated on the entire surface of the circuit forming area of the wafer W.

When the coating process is performed, the height of the photographing means 4 is adjusted so that the coating solution coated on the front surface of the mask 35 can be photographed. Thereafter, the photographing means 4 photographs the coating solution discharged from the nozzle 2. According to the photographed result, the discharge state determining program obtains a sectional area of the coating solution (before the nozzle 2 reaches the return position). The discharge state determining program monitors the variation of the sectional area. When the variation is large, the discharge state determining program determines that the discharge state is abnormal and issues an alarm. As a result, the operator stops the operation of the apparatus and performs a proper operation for checking the state of the nozzle 2. Alternatively, the program may be coded so as to cause the coating solution nozzle 2 to stop scanning the wafer W when an alarm takes place.

After the coating film has been formed in such a manner, for example the ultrasonic wave oscillator applies an ultrasonic wave to the wafer W so as to make the film thickness of the liquid film uniform. Thereafter, the wafer W is dried. As a result, a solvent contained in the liquid film is evaporated and thereby a resist film is obtained.

According to the foregoing coating apparatus, an experimental wafer of the same type as a product wafer (the front surface of the experimental wafer is the same as that of the product wafer) is loaded into the coating apparatus so as to perform an experimental coating process for the experimental wafer. As a result, the allowable range of the pitch dp of the nozzle 2 for each discharge flow amount according to the contact angle that depends on a product wafer and the concentration (viscosity) of the solid component of a coating solution used in the coating process, the parameters of the coating process can easily be set. Thus, the coating process can be quickly started.

In addition, the photographing means 4 photographs a coating solution coated in the coating process and monitors the discharge state of the nozzle 2. Thus, if the nozzle 2 has a defect, the operator can take a proper action against the defect. For example, the operator can stop the operation. Thus, the efficiency of the operation is high.

In the foregoing embodiment, the experimental coating process may be performed at a different place from the real coating process. In addition, it is not always place a mask on a wafer W. If a mask is not used, when the coating process is performed, a coating solution coated on the front surface of a wafer can be monitored by the photographing means.

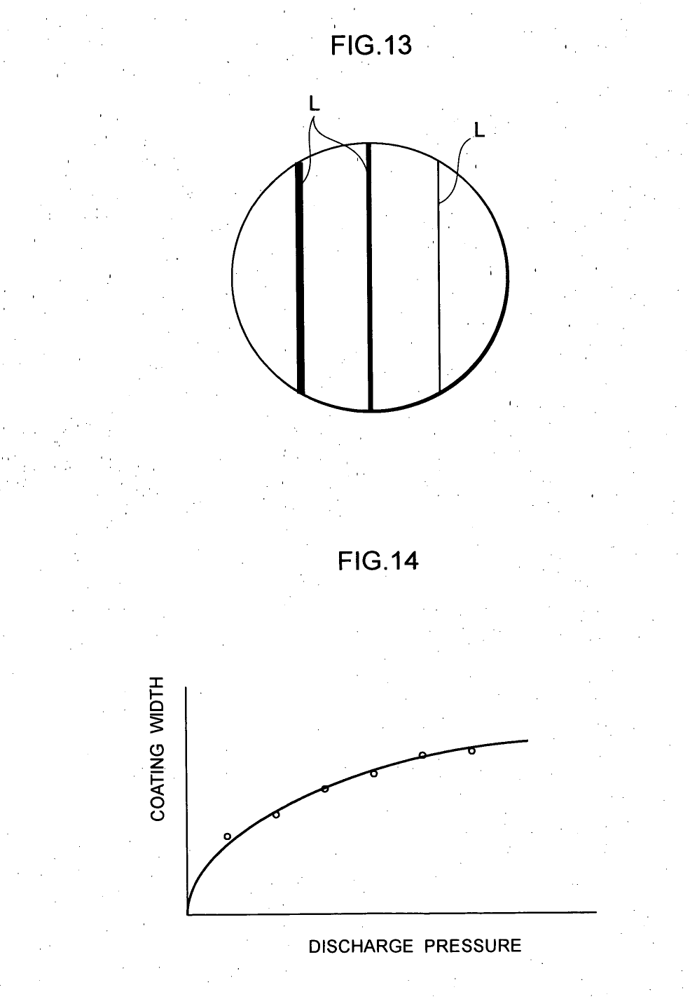

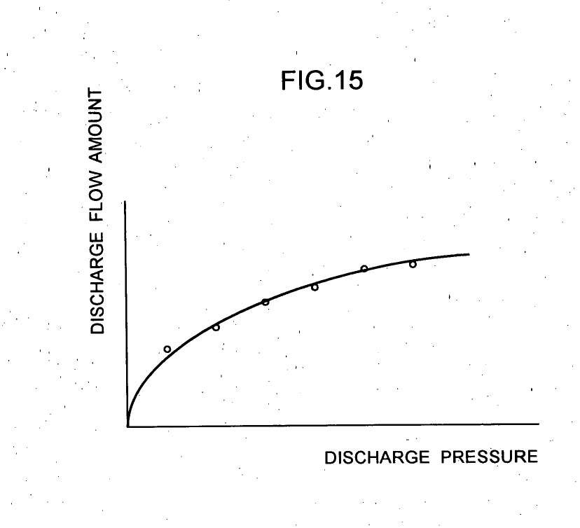

Next, an example of a preferred method for setting the discharge flow amount q of the nozzle 2 will be described. When the discharge flow amount q is set in the apparatus shown in FIG. 9 to FIG. 11, an experimental wafer of the same type as a product wafer to be processed is used. Several discharge pressures of the pump 24 (see FIG. 9) are set. Lines of the coating solution are drawn on each wafer under the individual discharge pressures. FIG. 13 shows lines L that are drawn on one wafer under for example three types of discharge pressures. The lines L are photographed by the photographing means 4 so as to obtain their coating widths. As shown in FIG. 14, the relation of the coating width and the discharge pressures is plotted so as to create a logical curve. With the expression (8), which represents the relation of the coating width and the discharge flow amount, the logical curve shown in FIG. 14 is converted into the relation of the discharge flow amount and the discharge pressure. As a result, a logical curve shown in FIG. 15 is created.

The relation of the discharge flow amount and the discharge pressure is stored in a storing portion of the controlling portion 5. When a desired discharge flow amount is input, a corresponding discharge pressure can be obtained. When the pump 24 is operated at the obtained discharge pressure, there are the following benefits. In other words, when a coating solution is coated with a particular discharge flow amount (for example, 1.0 cc/minute), since the pump 24 is operated with a discharge pressure that is input, the discharge pressure should be adjusted until the particular discharge flow amount is obtained. In contrast, when the relation of the discharge flow amount and the discharge pressure is stored, a desired discharge flow amount that is input is automatically converted into a corresponding discharge pressure. At the discharge pressure, which is a pressure of the pump 24 that has been set, it is operated. As a result, the coating solution is coated with the desired discharge flow amount.

When the bore of the coating solution nozzle 2 is changed, even if the discharge pressure is the same, the discharge flow amount is varied. However, in that method, it is not necessary to check the discharge flow amount of the nozzle 2 whenever the coating process is performed. Thus, the setting operation can easily be performed.

The discharge pressure and the discharge flow amount hydrodynamically have the relation that satisfies the following expression (10).

q=(α²−βΔp)^{1/2}−α (10)

where α and β represent variables; and ΔP represents a discharge pressure.

In other words, a solution discharged from the pump 24 is discharged through a pipe, the filter, and the nozzle. At that point, the solution is subject to a pressure loss (later, the discharge pressure). Besides that, there are other pressure losses due to a bend of a tube and a joint portion. These pressure losses are difficult to calculate. When all of them are considered, there is the relation of the discharge flow amount and the pressure loss (discharge pressure) that satisfies expression (11).

aq²+bq+Δp=0 (11)

where a, b, and c represent constants of terms of physical properties (viscosity or density) of a chemical solution, the size of the nozzle, and so forth. When a solution of the expression (11), which is a quadratic expression, is obtained, the expression (10) is obtained. The expression (10) is equivalent to the curve shown in FIG. 15. With the expressions (8) and (10), the relation of the coating width dw the discharge pressure Δp is given by expression (12). The expression (12) is equivalent to the curve shown in FIG. 14.

dw=[{(α²−βΔp)^{1/2}−α}/K]^{1/2} (12)

In the present embodiment, a case of which the scanning speed of the nozzle 2 is constant was described. Alternatively, the relation data of the discharge flow amount q and the coating width dw for each stepped scanning speed may be stored in the first storing portion 54. In addition, when the relation data of the discharge flow amount q and the pitch dp for each of a plurality of targets of the film thickness for each stepped scanning speed is stored in the second storing portion 55, even if the scanning speed is changed, conditions can easily and quickly be set.

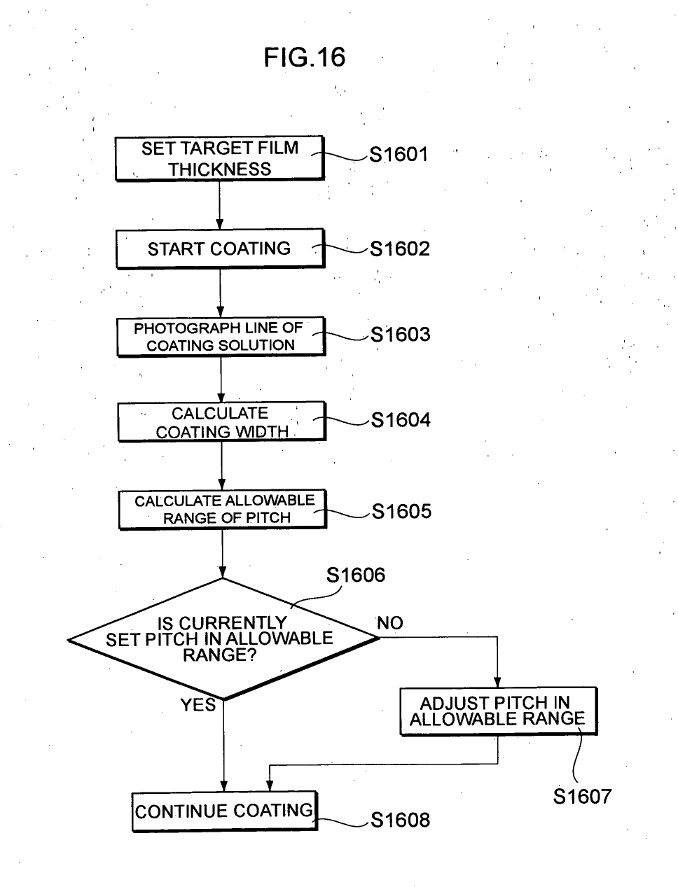

Moreover, in the present embodiment, a coating solution coated on a product substrate may be photographed by the photographing means 4. With the photographed result, a line having a coating width may be calculated on real time basis. Next, a case of which a coating process is performed on real time basis will be described with reference to FIG. 16.

First, the operator sets a film thickness target (at step 1601). In this case, it is assumed that the scanning speed of the nozzle 2 and the content of the solid component of a resist are constant. As shown in FIG. 12, a wafer W is scanned from a peripheral portion by the nozzle 2 so as to start coating a resist solution on the wafer W (at step 1602). At that point, a first line of the resist solution 8 is photographed (at step 1603). According to the photographed result, a coating width dw is calculated (at step 1604). In reality, in the same manner as the foregoing case, with the photographed result, a contact angle is obtained. As a result, the coating width dw is calculated. According to the coating width dw, in the same manner as the foregoing case, as shown in FIG. 5, an allowable range of a pitch dp is calculated (at step 1605). After the allowable range of the pitch has been calculated, it is determined whether or not the pitch of the nozzle 2 that has been set and at which the coating solution has been really coated on the wafer W is in the allowable range (at step 1606). When the pitch of the nozzle 2 that has been really set and at which the coating solution has been coated on the wafer W is in the allowable range, the wafer W is scanned by the nozzle 2 without a change of the pitch so as to continue the coating process (at step 1608). When the pitch of the nozzle 2 is not in the allowable range, the pitch of the nozzle 2 that has been really set and at which the coating solution has been coated on the wafer W is adjusted so that it is in the allowable range (at step 1607). Thereafter, the coating process is continued with the adjusted pitch. The pitch adjusting process should be performed before a second line of the coating solution is coated. The pitch adjusting process is automatically performed according to a determination of a CPU (not shown) of the controlling portion 5 (see FIG. 11).

[Second Embodiment]

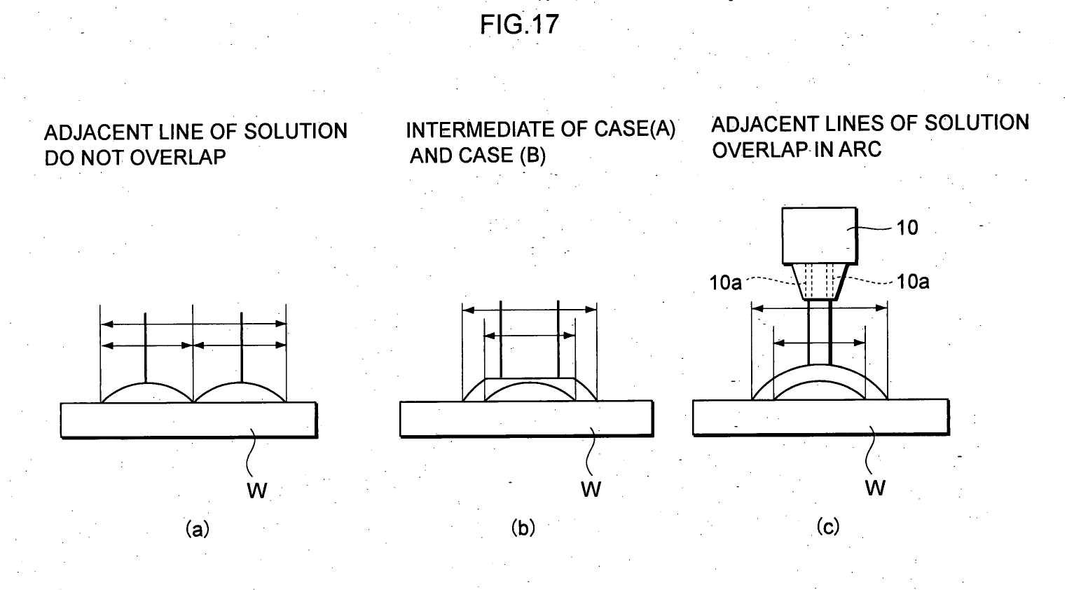

Next, a second embodiment of the present invention will be described. FIG. 17 is a schematic diagram showing cases of which coating solutions are discharged from nozzles 10 each having a plurality of discharge openings, for example two discharge openings 10a, the distance of the two discharge openings 10a is different in cases (a), (b), and (c). The case (a) shows that the distance of the two discharge openings 10a is larger than that of each of the cases (b) and (c) and that a coating solution is coated on the wafer W so that adjacent lines of the coating solution do not overlap. The case (c) shows that the distance of the discharge openings 10a is smaller than that of each of the cases (a) and (b) and that a coating solution is coated on the wafer W so that adjacent lines of the coating solution overlap in part of a substantially cylindrical shape (in an arc shape). The case (b) shows that the distance of the two discharge openings 10a is in the middle of that of each of the cases (a) and (c) and that a coating solution is coated on the wafer W so that adjacent lines of the coating solution overlap but in a non-cylindrical shape.

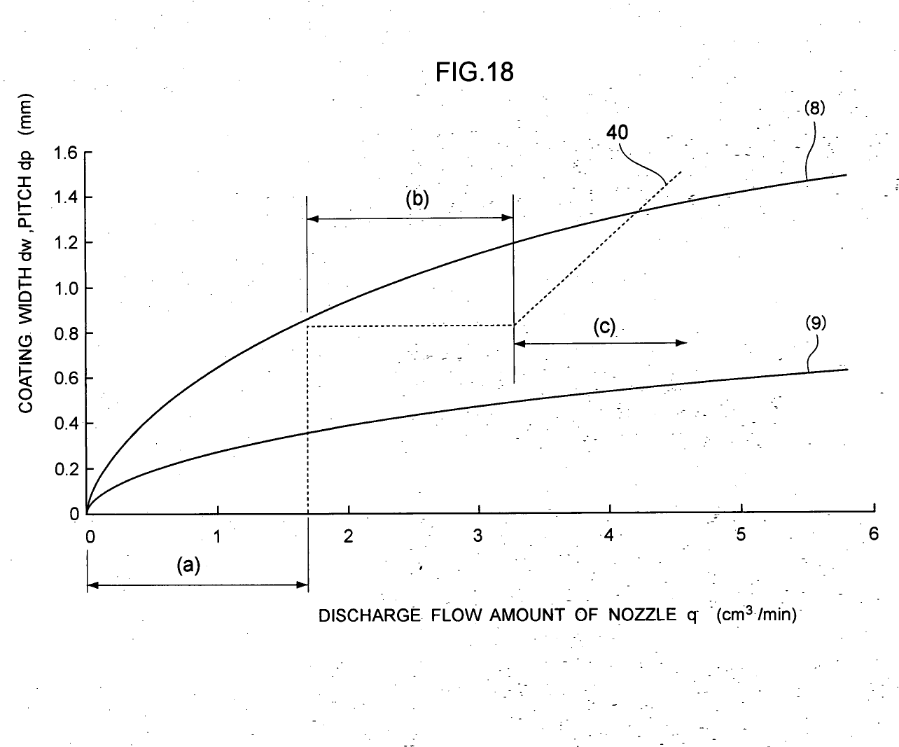

According to the present embodiment, assuming that the discharge flow amounts (cm³/minute) of the cases (a), (b), and (c) are the same, the amount of the coating solution coated on the unit area of the wafer W in the case (a) is the largest; the amount in the case (b) is the next largest; and the amount in the case (c) is the smallest. When such discharge states are correlated with the graphs of FIG. 8, a broken line 40 of FIG. 18 is obtained. In FIG. 18, regions (a) to (c) correspond to the cases (a) to (c) of FIG. 17, respectively. In the region (a), since adjacent lines of the coating solution do not overlap, considering that the coating solution is not substantially coated there, it is assumed that the coating width is 0. In the region (c), it is assumed that the coating width is proportional to the discharge flow amount. In the region (b), even if the discharge flow amount becomes large, since the adjacent lines of the coating solution are in the state (a), namely, a cylindrical shape, it can be assumed that the coating width is constant.

From the foregoing consideration, the first embodiment of the present invention can be applied to a case of which a coating process is performed using a plurality of nozzles whose distances are different.

[Third Embodiment]

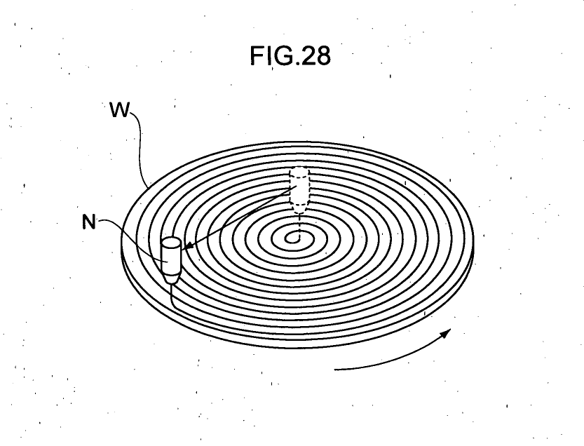

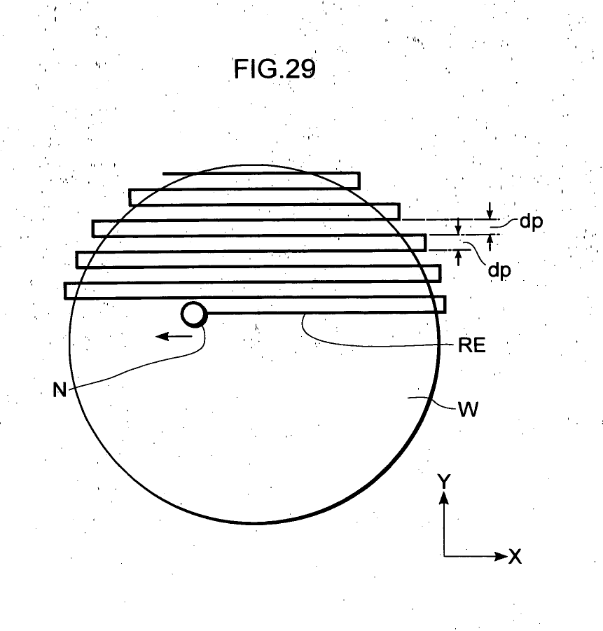

According to a third embodiment, polyimide or a resist solution is coated on a substrate such as a wafer so as to form a protection film or a resist film of a semiconductor device. As one example of the coating process, a chemical solution of which polyimide is dissolved with a solvent is further diluted with a solvent. For example, as shown in FIG. 28, while a wafer W is being rotated and a coating nozzle N is gradually moved in the radius direction of a wafer W, a costing solution is discharged on the front surface of the wafer W in such a manner that the coating solution is spirally coated thereon in a single stroke manner. In reality, a discharge speed of the coating solution to the wafer W is constant. In addition, lines of the coating solution are coated in the radius direction at an equal interval so that they are in contact without a space.

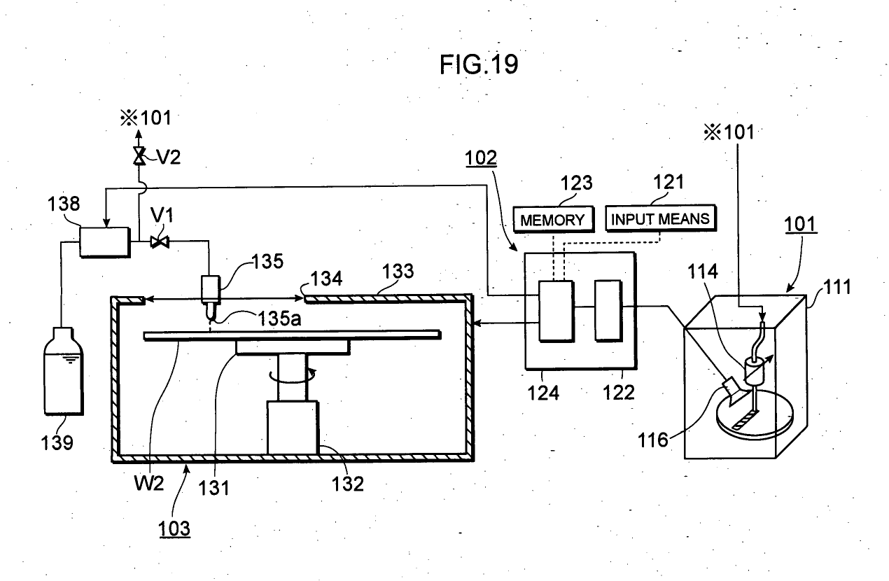

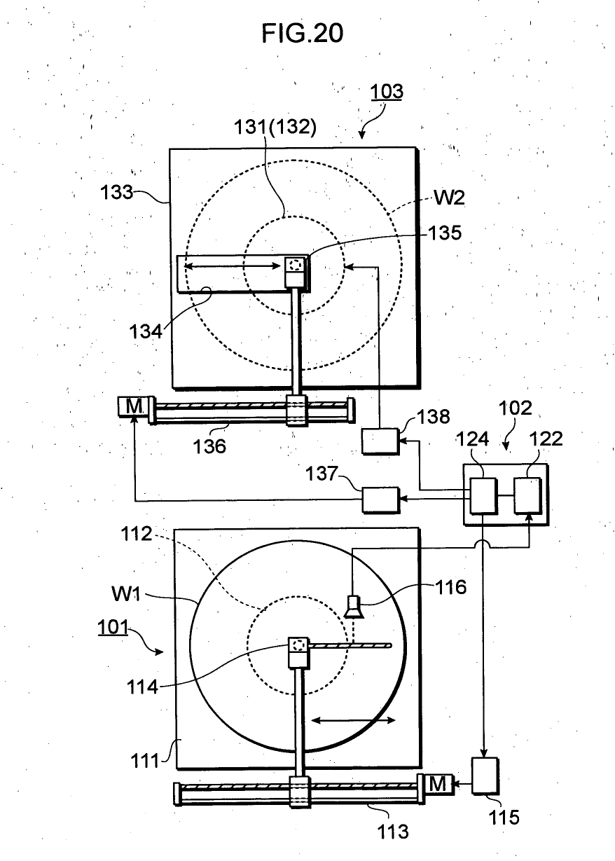

Next, with reference to schematic diagrams of FIG. 19 and FIG. 20, a case of which a polyimide solution or a resist solution as a coating solution is supplied and a polyimide film or a resist solution is formed on the front surface of a substrate by a coating apparatus according to the present invention will be described. First, the overall structure of the coating film forming apparatus will be described in brief. As shown in FIG. 19, the coating film forming apparatus mainly comprises three units that are a measuring portion 101, a controlling portion 102, and a coating portion 103. The measuring portion 101 coats a coating solution on an experimental substrate, photographs the coating solution coated on the substrate, and obtains image data. The controlling portion 102 includes a computer that obtains the line width of the coating solution according to the image data obtained by the measuring portion 101 and decides an optimum supply pattern of the coating solution according to the line width. The coating portion 103 supplies the coating solution from the coating nozzle to a product substrate according to the supply pattern and forms a coating film on the entire front surface of the product substrate. The measuring portion 101 and the coating portion 103 are housed in a casing (not shown) of the coating unit.

First, the measuring portion 101 will be described. Reference numeral 111 represents a case body. In the case body 111, a chuck 112 that sucks a wafer W1 as an experimental substrate from the rear surface side and horizontally holds it is disposed. Above the wafer W1 held by the chuck 112, a coating nozzle 114 is disposed. The coating nozzle 114 can be freely moved in an X direction by a driving portion 113 composed of for example a motor and a ball screw mechanism. The driving portion 113 is connected to the controlling portion 102 through a controller 115. The driving portion 113 causes the nozzle to scan the wafer W1 at a predetermined speed according to a control signal transmitted from for example a data processing portion 124.

A photographing means 116 composed of for example a CCD camera that photographs a coating solution coated in a line shape on the wafer W1 is disposed above the wafer W1 in such a manner that the photographing means 116 does not disturb the movement of the coating nozzle 114. The photographing means 116 is connected to an image processing portion 122 of the controlling portion 102 so that the state of the coating solution can be transmitted as image data.

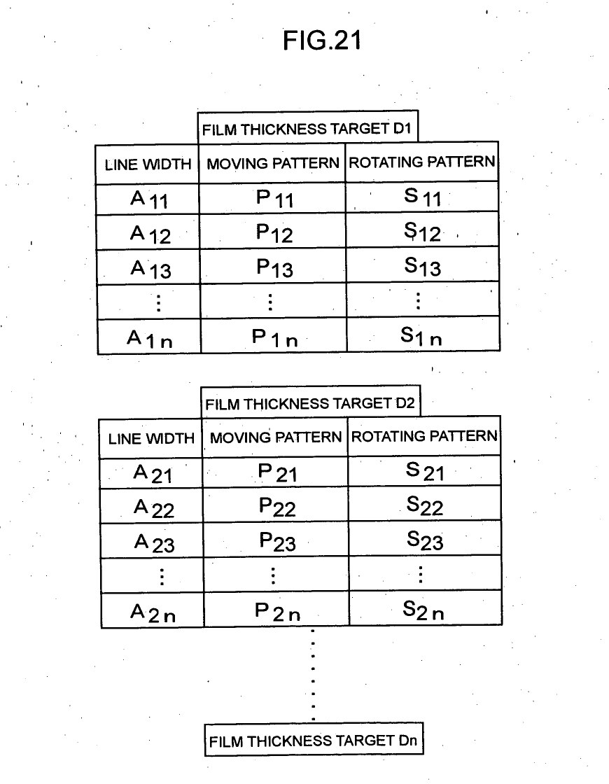

The controlling portion 102 comprises an input means 121, the image processing portion 122, and the data processing portion 124. The input means 121 is composed of for example a touch panel used to input an initial condition necessary to form a coating film. The image processing portion 122 obtains a line width of the coating solution with the image data obtained by the measuring portion 101. The data processing portion 124 references a data table shown in FIG. 21 stored in a memory 123 and decides a coating condition according to the measured value of the obtained line width. The controlling portion 102 controls a driving system and a coating solution supplying system of the coating portion 103 according to the coating condition and controls the driving operation of the measuring portion 101 not shown in FIG. 19. The controlling portion 102 is composed of a CPU, a storing means, and so forth not shown. However, for convenience, each necessary function is represented as a block.

The data table stores an optimum coating condition in which a coating film is coated on the entire surface of a product substrate with a uniform film thickness in a coating process performed by the coating portion 103. The data table stores data of experimental results performed in each condition. Data stored in the data table is decided in the following manner. Various types of wafers whose surface states are different (the types of thin films are different) are prepared. With each of a plurality of targets of the film thickness Dn (D1, D2, D3, . . . ), a combination of the type of a wafer and the type of a coating solution is changed. In each combination, a coating process is performed by the coating portion 103. In each combination of wafers and coating solutions, a moving pattern of a nozzle 135 of the coating portion 103 (that will be described later) and a coating pattern are changed. In each combination, the coating process is performed. A combination of a moving pattern of the coating nozzle 135 and a rotating pattern of a wafer of which the uniformity of the film thickness of the coating film is high is recorded.

Data is collected in such a manner. When a coating solution of particular type is coated on a wafer of particular type with a film thickness target D1, a coating condition of which the uniformity of the film thickness of the coating film is high, namely a combination of a moving pattern of the coating nozzle 135 and a rotating pattern of the wafer, in FIG. 21, as a pair of a moving pattern P11 and a rotating pattern S11, is stored in the data table.

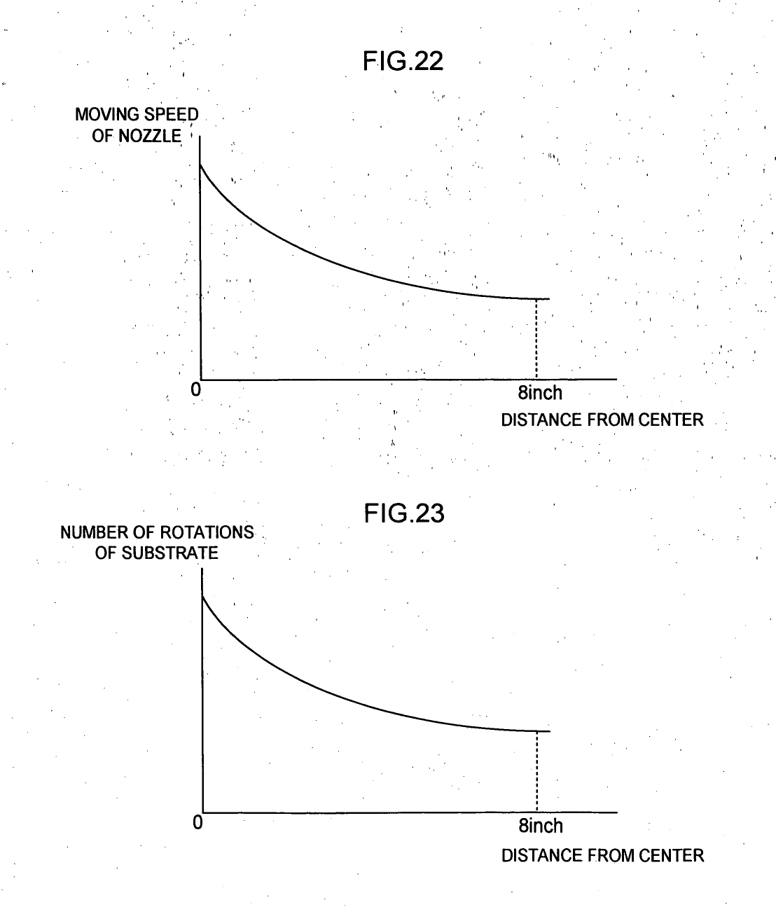

A moving pattern of the coating nozzle 135 represents the relation of the position of a wafer immediately below the coating nozzle 135 and the scanning speed thereof at the position. Since the peripheral speed of the wafer immediately below the coating nozzle 135 is constant, as the coating nozzle moves toward the outer periphery of the wafer, the scanning speed gradually decreases as represented by a right-downward curve. When the substrate is of eight inch type, the relation can be represented as shown in FIG. 22.

A rotating pattern represents the relation of the position of a wafer immediately below the coating nozzle 135 and the number of rotations of the wafer at that point. Since the peripheral speed of the wafer immediately below the coating nozzle 135 is constant, as the coating nozzle 135 moves toward the outer periphery of the wafer, the number of rotations gradually decreases as represented by a right-downward curve. When the substrate is of eight-inch type, the relation can be represented as shown in FIG. 23.

However, when data of all considerable combinations of wafers and coating solutions is collected, since the film thickness is also a parameter, the labor of the operator is very large. In addition, it is predicted that the types of films formed on wafers and the types of coating solutions will be changed in future. Thus, it is impossible to deal with all data. Thus, according to the present invention, to set combinations of the types of wafers and the types of coating solutions is to set combinations of surface states of wafers and viscosities of coating solutions. In other words, how lines of coating solutions are formed (sectional shapes) is decided. An optimum coating condition of combinations of the types of wafers and the types of coating solutions represents that even if combinations of the types of wafers and the types of coating solutions are different, as long as lines of coating solutions are coated in the same manner, these combinations can be used as the same coating condition.

Thus, according to the present invention, when the measuring portion 101 has decided combinations of the types of wafers and the types of coating solutions and found an optimum coating condition, the measuring portion 101 sets a discharge speed with the same wafer in advance, the same coating solution, and the same coating nozzle 135. While moving the coating nozzle 135 at a particular constant scanning speed, the measuring portion 101 draws for example one straight line of the coating solution on the wafer. The photographing means 116 photographs the line. The photographed line width and the optimum coating condition, namely, a combination of a moving pattern of the coating nozzle 135 and a rotating pattern of the wafer, are correlated and stored in the data table. In such a manner, as a result, as will be described later, when the operator performs an experimental coating process with the measuring portion 101 for an experimental wafer whose type is the same as a product wafer, he or she can know an optimum coating condition according to the line width.

Next, the coating portion 103 will be described. Reference numeral 131 represents a substrate holding portion that vacuum sucks a wafer W2 as a product wafer from the rear surface side and horizontally holds the wafer W2. The lower side of the substrate holding portion 131 is supported by a rotating mechanism 132 (see FIG. 19) that rotates the substrate holding portion 131 around a vertical axis when a coating process is performed. The substrate holding portion 131 and the rotating mechanism 132 are surrounded by a case body 133 whose ceiling portion has a slit 134 that extends in the X direction. In the case body 133, devices that control an atmospheric gas in a narrow space of the coating unit. The devices are for example a temperature and humidity adjusting means, a solvent vapor supplying means, and so forth. After a coating solution is coated, these devices can prevent it from evaporating. A wafer transferring opening (not shown) is formed in a side surface of the case body 133. The wafer transferring opening is opened and closed by for example a shutter (not shown).

Above the case body 133, the coating nozzle 135, which supplies the coating solution to the wafer W2, is disposed. The coating nozzle 135 is structured so that it is moved in the X direction by a driving portion 136 disposed outside the case body 133 in the state that a discharge opening 135a at the lower end of the coating nozzle 135 protrudes in the case body 133 through the slit 134. The rotating mechanism 132 and the driving portion 136 are connected to the controlling portion 102 through a controller 137 so that they are driven according to a control signal received from the data processing portion 124.

Returning to FIG. 19, a coating solution supplying system of the measuring portion 101 and the coating portion 103 will be described. First, the coating portion 3 will be described. On the base side of the coating nozzle 135, a coating solution supplying source 139 is connected through a valve V1 and a pump 138. In the coating solution supplying source 139, a polyimide solution of which a polyimide component as a component of a coating film is dissolved with a solvent such as NMP (N-methyl pyrrolidone) is stocked. The supplying speed of the polyimide solution discharged from the coating nozzle 135 to the wafer W2 is adjusted by the controlling portion 102 that controls the pump 138. In such a structure, a bellows type pump is used as the pump 138. The bellows type pump is a pump that is capable of extending and contracting bellows so as to switch timings of sucking and discharging a solution. The extending operation and contracting operation of the bellows are performed by for example a stepping motor. Thus, the driving control of the stepping motor is performed by for example the controlling portion 102 so as to vary the extension and contraction width. As a result, the discharge speed of the polyimide solution is adjusted. According to the present embodiment, adjustment positions of the bellows and the stepping motor that adjust the discharge speed of the pump 138 are omitted.

On the other hand, as was described above, since the same coating solution is used by the measuring portion 101 and the coating portion 103, a downstream pipe of the pump 138 branches in front of the valve V1 and extends to the coating nozzle 114 of the measuring portion 1 through the valve V2.

The coating nozzle 135 and the coating nozzle 114 have the same function. In addition, the wafer W1 and the wafer W2 for which a coating process is performed are of the same type. Thus, the wafer W1 as an experimental substrate may be one taken from many product wafers W2. Alternatively, the wafer W1 may be another wafer having the same surface state as the wafer W2 (namely, a coating film coated on the wafer W1 is the same as that on the wafer W2). However, in this example, it is assumed that wafers of the same type are used. “Line width measuring means” in the “what is claimed is” section includes the photographing means 116, the image processing portion 122, and a calculating means of a computer.

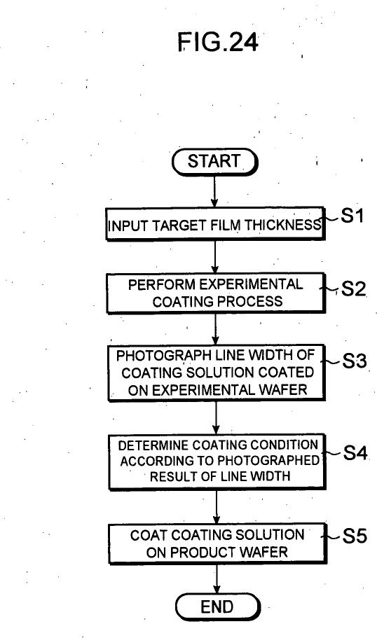

Next, with reference to a flow chart of FIG. 24, an operation of the present embodiment will be described. First, the operator decides a film thickness target of a coating film to be formed on a product wafer W2 and inputs the decided film thickness target to the input means 121 of the controlling portion 102 (at step S1). When the film thickness target is input, data corresponding to the film thickness target is selected from the data table of the memory 123. A substrate as an experimental wafer having the same surface state as a product wafer is taken from a group of product wafers and the taken experimental wafer is loaded into the measuring portion 1. One line of the coating solution is drawn on the experimental substrate by the coating nozzle 114 (at step S2).

The scanning speed of the coating nozzle 114 is the same as the scanning speed of which data of the data table was collected. The coating solution used for the experimental wafer is the same as that for the product wafer W2. A line of the coating solution is photographed by the photographing means 116 (at step S3). A line width is obtained from the line of the coating solution photographed by the image processing portion 122 of the controlling portion 102. An optimum coating condition for the line width, namely, a combination of a moving pattern of the coating nozzle 135 and a rotating pattern of the wafer, is decided with the data corresponding to the film thickness target of the data table stored in the memory 123 (at step S4).

Thereafter, the product wafer W2 is loaded from a transferring opening (not shown) into the case body 133 by an external arm (not shown). By the elevating operation of the substrate holding portion 131 and the cooperating operation of the arm, the wafer W2 is held by the substrate holding portion 131. Thereafter, according to the moving pattern of the coating nozzle 135 and the rotating pattern of the wafer decided by the experimental coating process, the controlling portion 102 controls the scanning speed of the coating nozzle 135 through the motor M and controls the rotation of the wafer W2 through the rotating mechanism 132 so as to spirally coat the coating solution on the wafer W2 as shown in FIG. 28. Thereafter, the wafer W2 is unloaded from the case body 133 and then conveyed to for example a reduced pressure drying unit. In the reduced pressure drying unit, the solvent is evaporated and thereby a coating film containing a coating component is obtained.

According to the foregoing embodiment, an optimum coating condition of combinations of the types of wafers and the types of coating solutions represents that even if combinations of the types of wafers and the types of coating solutions are different, as long as lines of coating solutions are coated in the same manner, these combinations can be used as the same coating condition. Thus, before a coating process is performed for a product wafer, a coating process is performed for an experimental wafer by the measuring portion 101. According to the obtained line width of the coating solution formed on the experimental wafer, a coating condition of the coating solution for the product wafer is decided. Thus, regardless of the type of a coating solution and the type of a wafer, by performing an experimental coating process, an optimum coating condition can be obtained. As a result, the labor of the initial setting operation can be alleviated. As a result, since the total time necessary for the coating process can be shortened, the throughput of the coating process can be improved.

According to the present embodiment, the line width of a coating solution coated on a product wafer W2 can be measured on real time basis. In this case, immediately after the coating process is performed, the line width of the coating solution is measured. Thereafter, a combination of a moving pattern and a rotating pattern corresponding to the measured line width is selected. With the selected combination, the movement of the nozzle 135 and the rotation of the wafer are controlled so as to supply the coating solution.

According to the present embodiment, a coating solution is supplied to the measuring portion 101 and the coating portion 103 through the coating solution supplying source 139 and the pump 138 that are provided in common. However, as long as a coating solution can be supplied in the same condition, independent coating solution supplying systems may be provided for the measuring portion 101 and the coating portion 103.

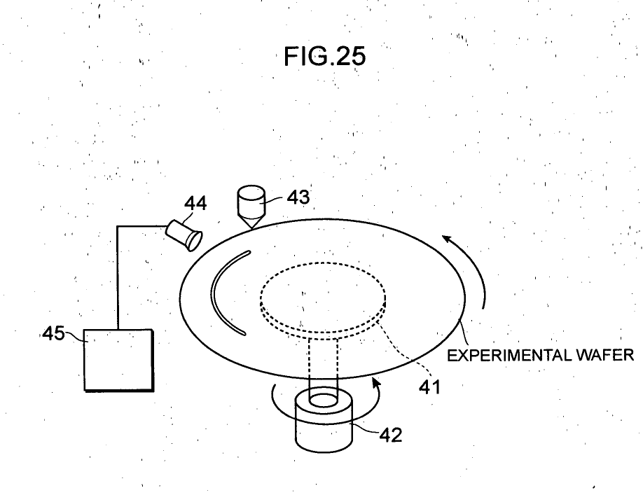

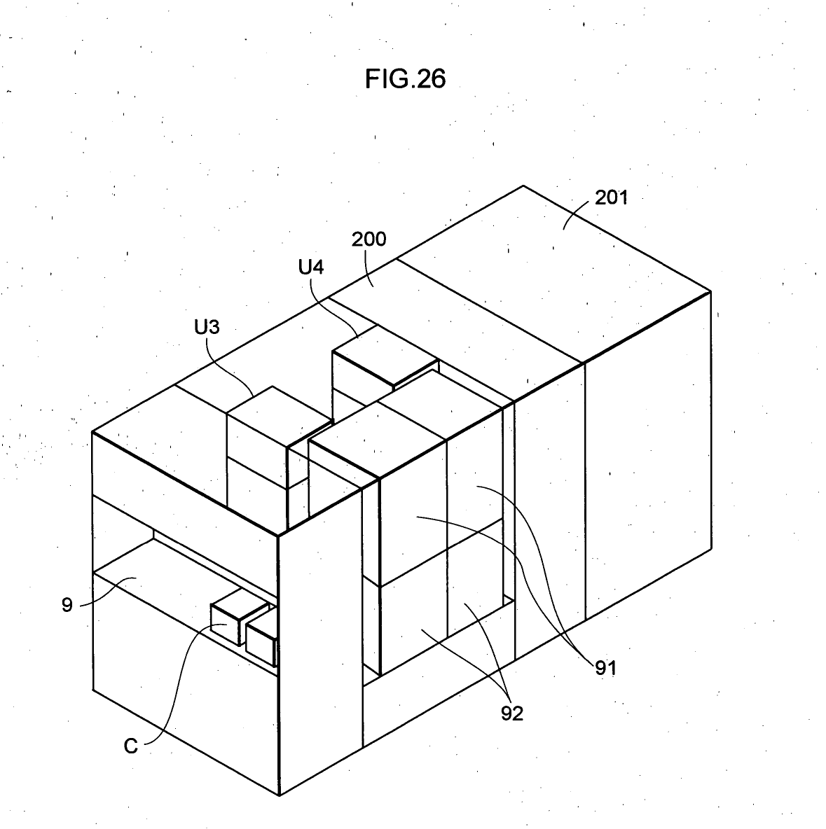

According to the present invention, as shown in for example FIG. 25, a coating process for the wafer W1 and a coating process for the wafer W2 can be performed by a single apparatus. In FIG. 25, reference numeral 141 represents a wafer holding portion that horizontally holds a wafer. The wafer holding portion 141 can be freely rotated by a rotating mechanism 142 disposed on a lower side of the wafer holding portion 141. A coating nozzle 143 is disposed above the wafer held by the wafer holding portion 141. A driving portion (not shown) causes the coating nozzle 143 to scan the wafer for example from the center in the radius direction. A photographing means 144 is disposed so that the photographing means 144 does not prevent the coating nozzle 143 from moving. The photographing means 144 obtains image data of the coating solution.

The experimental wafer W1 is held by the substrate holding portion 141. The position of the coating nozzle 143 is fixed. While only the wafer W1 is being rotated, the coating solution is supplies so that the coating nozzle 143 draws a line in an arc shape. Thereafter, the arc-shaped line of the coating solution is photographed and the line width thereof is measured. Since an experimental coating process is performed for the wafer W1, unlike the product wafer W2, it is not necessary to perform the coating process for the entire surface of the wafer W1. The photographed image data is transmitted to a computer 145. The computer 145 measures the line width of the coating solution. Thereafter, the wafer W1 is removed from the wafer holding portion 141. Instead, a product wafer W2 is held by the wafer holding portion 141. According to the measured line width, a coating condition is decided in the same manner as the foregoing embodiment. Likewise, a coating process is performed for the product wafer W2.

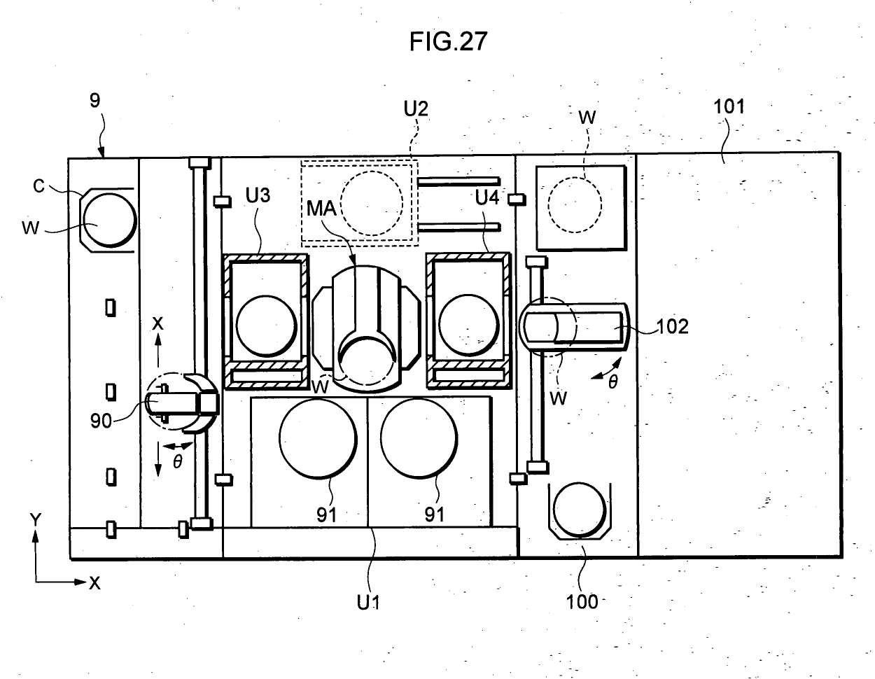

Next, with reference to FIG. 26 and FIG. 27, an example of which a coating apparatus according to the first embodiment, the second embodiment, or the third embodiment is incorporated in a coating unit will be described. In FIG. 26 and FIG. 27, reference numeral 9 represents a loading and unloading stage through which a wafer cassette is loaded and unloaded. A cassette C that contains for example 25 wafers is placed on the loading and unloading stage 9 by for example an automatic conveying robot. An arm 90 that transfers a wafer W is disposed on the loading and unloading stage 9 so that the transferring arm 90 can be freely moved in the X, Y, and Z directions and rotated by θ (around the vertical axis). On the inner side of the loading and unloading stage 9, namely, on the right side viewed from the transferring arm 90, a coating and developing system unit u1 (composed of coating units 92 and developing units 91) are disposed. On the left side, the outer side, and the inner side of the loading and unloading stage 9, heating and cooling system units u2, u3, and u4 each of which is composed of many units that are stacked are disposed, respectively. A wafer conveying arm MA is disposed so as to transfer a wafer W among the coating units 92, the developing units 91, the heating and cooling system units U2, U3, and U4. The wafer conveying arm MA can be freely elevated, moved in the left, right, forward, and backward directions, and rotated around the vertical axis. However, in FIG. 27, for simplicity, the unit u2 and the wafer conveying arm MA are not shown.

In the coating and developing unit, the two developing units 91 as for example upper units are disposed on the two coating units 92 as for example lower units. In the heating and cooling system units U2, U3, and U4, heating units, cooling units, hydrophobic treatment process units, and so forth are disposed on seven shaves.

The foregoing portion, which contains the coating and developing system unit and the heating and cooling system units, is referred to as a process station block. On the inner side of the process station block, an exposing apparatus 201 is connected through an interface block 200. Through the interface block 200, a wafer is transferred from and to the exposing apparatus 201 by a wafer conveying arm 202 that can be freely elevated, moved in the left, right, forward, and backward directions, and rotated around the vertical axis.

Next, a flow of a wafer in the apparatus will be described. First, a wafer cassette C that contains wafers W is conveyed from the outside of the apparatus to the loading and unloading stage 9. A wafer W is taken out of the wafer cassette C by the wafer conveying arm 90. The wafer W is transferred to the wafer conveying arm MA through a transferring table that is one of shelves of the heating and cooling unit U3. Thereafter, one process portion of one shelf of the unit U3 performs the hydrophobic process for the wafer W. Thereafter, one of the coating units 92 coats a resist solution on the wafer W. As a result, a resist film is formed on the wafer W. The wafer W on which the resist film has been coated is heated by one of the heating units. Thereafter, the wafer W is conveyed to one of the cooling units that can transfer the wafer W to the wafer conveying arm 202 of the interface block 200 of the unit U4. After the wafer W is processed by the cooling unit, the wafer W is conveyed to the exposing apparatus 201 through the interface block 200 and the wafer conveying arm 202. The exposing apparatus 201 exposes the wafer W through a mask corresponding to a pattern. The wafer W, which has been exposed, is received by the wafer conveying arm 202. The wafer conveying arm 202 conveys the wafer W to the wafer conveying arm MA of the process station block through the transferring unit of the unit U4.

Thereafter, the wafer W is heated to a predetermined temperature by one of the heating units. Thereafter, the wafer W is cooled to a predetermined temperature by one of the cooling units. Thereafter, the wafer W is conveyed to a developing unit 91. The developing unit 91 performs a developing process for the wafer W. As a result, a resist mask is formed on the wafer W. Thereafter, the wafer W is returned to the wafer cassette C on the loading and unloading stage 9.

A substrate processed according to the present invention may be an LCD substrate or an exposing mask. In addition, a coating solution processed according to the present invention is not limited to a resist solution. For example, a solution for forming an inter-layer insulation film, a solution for forming a high conductivity film, a solution for forming a ferroelectric film, a silver paste, or the like may be used.

### INDUSTRIAL APPLICABILITY

As was described above, according to the present invention, a coating solution is coated in a single stroke manner on a substrate. Parameters for a coating process can easily be set. As a result, the labor of the operator can be alleviated. In particular, when a coating solution is coated spirally on a substrate, a coating film can be formed with a uniform thickness.

What is claimed is:

1. A coating apparatus, comprising:
a supplying mechanism for supplying a coating solution to a substrate while alternately moving a nozzle in a first direction and in a second direction almost perpendicular to the first direction, and relatively to the substrate;
a first storing portion for storing a first relation data of a discharge flow amount of the coating solution and a coating width of a line of the coating solution supplied to the substrate at a predetermined moving speed of the nozzle;
a second storing portion for storing a second relation data of the discharge flow amount and a pitch that is a moving distance of the nozzle in the second direction almost perpendicular to the first direction for each of a plurality of targets of the film thickness on the substrate at the predetermined moving speed of the nozzle; and
means for calculating an allowable range of the pitch according to a selected target of the plurality of targets, the stored first relation data and the second relation data.

2. The coating apparatus as set forth in claim 1, further comprising:
a controlling portion for controlling the supplying mechanism so as to move the nozzle in the calculated allowable range of the pitch and cause the nozzle to supply the coating solution to the substrate.

3. The coating apparatus as set forth in claim 1, further comprising:
photographing means for photographing the line of the coating solution supplied to the substrate; and
means for calculating the coating width of the line of the coating solution of the first relation data according to a photographed result of the photographing means.

4. The coating apparatus as set forth in claim 3,
wherein the coating width of the line of the coating solution is calculated according to a contact angle of the coating solution obtained from the photographed result of the photographing means.

5. The coating apparatus as set forth in claim 1,
wherein the calculating means is configured to treat one of a first value obtained from a graph representing the first relation data and a second value of which a margin is allowed to the first value as an upper limit value of the pitch.

6. The coating apparatus as set forth in claim 5,
wherein the upper limit value of the pitch is calculated in a condition of which the pitch is smaller than the coating width of the line of the coating solution.

7. The coating apparatus as set forth in claim 5,
wherein the calculating means for calculating the allowable range of the pitch is configured to obtain a limit pitch of which the coating solution protrudes from a predetermined position dependent of the pitch as a function of the coating width according to a geometric model and to obtain a lower limit value of the pitch according to the limit pitch.

8. The coating apparatus as set forth in claim 1, further comprising:
means for displaying the allowable range of the pitch.

9. The coating apparatus as set forth in claim 1,
wherein the second relation data is stored in the second storing portion according to each of a plurality of viscosities of the coating solution.

10. A coating method for supplying a coating solution to a substrate while alternately moving a nozzle in a first direction and a second direction almost perpendicular to the first direction, and relatively to the substrate, the coating method comprising the steps of:
calculating an allowable range of a pitch according to a first relation data of a discharge flow amount of the coating solution and a coating width of a line of the coating solution supplied to the substrate at a predetermined moving speed of the nozzle, a second relation data of the discharge flow amount and the pitch that is a moving distance of the nozzle in the second direction almost perpendicular to the first direction for each of a plurality of targets of the film thickness on the substrate at the predetermined moving speed, and a selected target of the plurality of targets; and
supplying the coating solution to the substrate in the calculated allowable range of the pitch.

11. The coating method as set forth in claim 10, further comprising the steps of:
photographing a line of the coating solution supplied to the substrate; and
calculating a coating width of the line of the coating solution of the first relation data according to a photographed result of the photographing step.

12. The coating method as set forth in claim 11,
wherein the coating width of the line of the coating solution is calculated according to a contact angle of the coating solution obtained from the photographed result.

13. The coating method as set forth in claim 10,
wherein the calculating step for calculating the allowable range of the pitch treats one of a first value obtained from a graph that representing the first relation data and a second value of which a margin is allowed to the first value as an upper limit value of the pitch.

14. The coating method as set forth in claim 13,
wherein the upper limit value of the pitch is calculated in a condition of which the pitch is smaller than the coating width of the line of the coating solution.

15. The coating method as set forth in claim 13,
wherein the calculating step for calculating the allowable range of the pitch having the steps of:
obtaining a limit pitch of which the coating solution forward protrudes from a predetermined position that dependent of the pitch as a function of the coating width according to a geometric model; and
obtaining a lower limit value of the pitch according to the limit pitch.

16. The coating method as set forth in claim 10,
wherein the second relation data is provided for each of the plurality of viscosities of the coating solution.

17. The coating method as set forth in claim 10, further comprising the steps of:
forming a line of the coating solution while moving the nozzle to an experimental substrate having the same surface state as the substrate as a product substrate and supplying the coating solution to the experimental substrate;
storing the first relation data and the second relation data when the coating solution is supplied to the experimental substrate; and
supplying the coating solution to a product substrate in the allowable range of the pitch,
wherein the calculating step is preceded by the forming step, the storing step, and the supplying step.

18. A coating apparatus for causing a nozzle to face a substrate horizontally held by a substrate holding portion, causing the nozzle to discharge the coating solution while moving the nozzle in an X direction, and relatively moving the nozzle in a Y direction against the substrate holding portion, and repeating the operations so as to coat the coating solution on the substrate and form a coating film thereon, the apparatus comprising:
executing means for causing the nozzle to scan an experimental substrate having the same surface state as the substrate as a product substrate, while causing the nozzle to supply the coating solution to the experimental substrate so as to form a line of the coating solution on the experimental substrate;
photographing means for photographing the line of the coating solution;
a first calculating means for obtaining relation data of a flow amount discharged from the nozzle at a scanning speed for a real coating process and an allowable range of a pitch that is an intermittent moving distance of the product substrate against the nozzle in a Y direction according to a photographed result of the photographing means;
storing means for storing a relation data of the flow amount of the nozzle dependent of a target of a film thickness on the substrate at the scanning speed for the real coating process and the pitch; and
a second calculating means for calculating the allowable range of the pitch according to the relation data of the flow amount and the pitch according to the target of the film thickness and the relation data obtained by the first calculating means.

19. The coating apparatus as set forth in claim 18,
wherein the calculating means is configured to obtain the relation data according to a contact angle of the contact solution obtained from the photographed result.

20. The coating apparatus as set forth in claim 19,
wherein the first calculating means is configured to obtain a graph representing a relation of the flow amount of the nozzle and a coating width of the line of the coating solution according to the contact angle and treats one of a first value obtained from the graph and a second value of which a margin is allowed to the first value as an upper limit value of the pitch.

21. The coating apparatus as set forth in claim 18,
wherein the calculating means is configured to obtain a limit pitch of which the coating solution forward protrudes from a predetermined position dependent of the pitch for the real coating process as a function of the coating width according to a geometric model and to obtain a lower limit value of the pitch according to the limit pitch.

22. The coating apparatus as set forth in claim 18,
wherein the pitch allowable range deciding means has means for displaying the allowable range of the pitch.

23. The coating apparatus as set forth in claim 18,
wherein the executing means includes a program coded so that while the experimental substrate is being held by the substrate holding portion, an experimental coating process is performed with the nozzle used for the product substrate.

24. The coating apparatus as set forth in claim 23,
wherein the photographing means is disposed so as to move in the Y direction relative to the substrate holding portion and configured to photograph the coating solution discharged from the nozzle for the real coating process, and
wherein the coating apparatus further comprises:
determining means for determining a discharge state of the nozzle according to the photographed result of the photographing means.

25. The coating apparatus as set forth in claim 24,
wherein when the determining means determines that discharge state of the nozzle is defective, the supply of the coating solution to the substrate is stopped.

26. The coating apparatus as set forth in claim 24,
wherein the determining means determines the discharge state of the nozzle according to a sectional area of a line of the coating solution obtained from the photographed result.

27. A coating apparatus, comprising:
means for supplying the coating solution on a front surface of a substrate in a spiral shape while relatively moving a nozzle for discharging a coating solution in a radius direction of the substrate being rotated;
a storing portion for correlatively storing, for each of a plurality of targets of the film thickness, a line width of the coating solution supplied to the substrate, the moving pattern defining a relation of a position of the nozzle on the substrate and a moving speed of the nozzle and a rotating pattern defining a relation of the position of the nozzle on the substrate and the number of rotations of the substrate; and
a controlling portion for controlling a movement of the nozzle and the rotation of the substrate according to the line width of the coating solution, the moving pattern, and the rotating pattern stored in the storing portion so as to supply the coating solution to the substrate.

28. The coating apparatus as set forth in claim 27, further comprising:
means for measuring the line width of the coating solution supplied to the substrate;
wherein the controlling means is configured to read the moving pattern and the rotating pattern according to the line width of the coating solution measured by the measuring means and control the movement of the nozzle and the rotation of the substrate according to the read information.

29. The coating apparatus as set forth in claim 28,
wherein the measuring means have means for photographing a line of the coating solution and means for processing a photographed image and obtaining the line width.

30. The coating apparatus as set forth in claim 28,
wherein the substrate includes a product substrate and an experimental substrate having the same front surface as the product substrate and used to perform an experimental coating process,
wherein the coating apparatus further comprises:
experimental coating means for experimentally coating the coating solution on the experimental substrate, and
wherein the measuring means is configured to measure a line width of the coating solution coated on the experimental substrate by the experimental coating means.

31. A coating method for relatively moving a nozzle for discharging a coating solution in a radius direction of a substrate being rotated while supplying the coating solution on a front surface of the substrate in a spiral shape, the coating method comprising the steps of:
reading a combination information of a moving pattern and a rotating pattern according to a predetermined line width for each of a plurality of targets of the film thickness, from information of which a line width of the coating solution supplied to the substrate, the moving pattern defining a relation of a position of the nozzle on the substrate and a moving speed of the nozzle and a rotating pattern defining a relation of the position of the nozzle on the substrate and the number of rotations of the substrate are correlatively stored; and
controlling a movement of the nozzle and a rotation of the substrate according to the read combination information and supplying the coating solution to the substrate.

32. The coating method as set forth in claim 31, further comprising the step of:
measuring the line width of the coating solution supplied to the substrate before the reading step;
wherein the moving pattern and the rotating pattern according to the line width of the coating solution measured by the measuring step are read in the reading step; and
wherein the movement of the nozzle and the rotation of the substrate according to the read information are controlled in the controlling step.

33. The coating method as set forth in claim 32,
wherein the measuring step further comprises the steps of:
photographing a line of the coating solution; and
processing the photographed image and calculating the line width.

34. A coating apparatus for coating solution on a front surface of a product substrate horizontally held by a substrate holding portion in a spiral shape while rotating the product substrate around a vertical axis and relatively moving a nozzle in a radius direction of the product substrate and causing the nozzle to discharge the coating solution, the coating apparatus comprising:
experimentally coating means for experimentally coating the coating solution on an experimental substrate having the same surface as the product substrate;
line width measuring means for measuring a line width of the coating solution coated on the experimental substrate coated by the experimental coating means;
a storing portion for correlatively storing the line width of the coating solution coated on the experimental substrate, a moving pattern defining a relation a position of the nozzle and a moving speed of the nozzle in a real coating process for the product substrate, and a rotating pattern that defines the position of the nozzle and the number of rotation of the substrate; and
a controlling portion for reading the moving pattern and the rotating pattern from the storing portion according to the line width of the coating solution measured by the line width measuring means and controlling the nozzle and the substrate holding portion according to the read data so as to form the coating film on the product substrate.
